(19) United States
(12) Patent Application Publication
(10) Pub. No.: US 2009/0043612 A1
(43) Pub. Date: Feb. 12, 2009

(54) Electronic Health Management System

(76) Inventors: Erwin G. Szela, JR., Inverness, IL (US); David Feerst, Northfield, IL (US); Paul D. Szela, Walnut Creek, CA (US)

Correspondence Address: NIXON PEABODY, LLP, 161 N. CLARK ST., 48TH FLOOR, CHICAGO, IL, 60601-3213, US

(21) Appl. No.: 12/187,740

(22) Filed: Aug. 7, 2008

Related U.S. Application Data
(60) Provisional application No. 60/963,764, filed on Aug. 7, 2007.

(51) Int. Cl. G06F 19/00

(52) U.S. Cl. 705/3

(57) ABSTRACT

A method and system of aggregating, integrating and reporting medical data for the purpose of encouraging the use of a health care program recommended to a patient by a health care provider, comprises maintaining a database of recommended health care actions by patient and health care provider; maintaining a database of recommended changes in recommended health care actions by patient and health care provider; requesting agreement by a health care provider to the recommended changes for at least one patient of that provider; communicating to that patient (1) the recommended changes and (2) the agreement by the health care provider to such recommended changes; maintaining a database of actual changes in recommended health care actions by health care provider; and delivering to at least certain of the health care providers an incentive to recommend health care actions that include the recommended changes.

### CROSS REFERENCE TO RELATED APPLICATIONS

This application claims priority to U.S. Provisional Application Ser. No. 60/963,764 filed Aug. 7, 2007.

### STATEMENT REGARDING FEDERALLY SPONSORED R&D

### References

| | | |
|---|---|---|
| 5319543 | June 1994 | Wilhelm |
| 5415167 | May 1995 | Wilk |
| 5471382 | November 1995 | Tallman |
| 5517405 | May 1995 | McAndrew, et. al. |
| 5572421 | November 1996 | Altman, et. al. |
| 5724968 | March 1998 | Iliff |
| 5832450 | November 1998 | Myers, et. al. |
| 6001060 | December 1999 | Churchill, et. al. |
| 6032678 | March 2000 | Rottem |
| 6083248 | July 2000 | Thompson |
| 6247002 | June 2001 | Steels |
| 6601055 | July 2003 | Roberts |
| 6748353 | June 2004 | Iliff |
| 6804787 | October 2004 | Dick |
| 7174335 | February 2007 | Kameda |
| 7181438 | February 2007 | Szabo |
| 7234064 | June 2007 | Menshick, et. al. |
| 7272601 | September 2007 | Wang, et. al. |
| 7373375 | May 2007 | Suzuki |
| 7269580 | September 2007 | Matichuk |
| 7297111 | November 2007 | Iliff |
| 7315858 | January 2008 | Potok, et. al |
| 7319976 | January 2008 | Peckover |
| 7321861 | January 2008 | Oon |
| 7386526 | June 2008 | Chappel |

### OTHER REFERENCES

“Value Driven Health Care Home” 2008, www.hhs.gov/valuedriven/
Legorreta, Antonio P., M.D., “Patient Care Improved by Doctor ‘Pay-For-Performance’, Health Services Research, Department of Health Services, UCLA School of Public Health, January, 2008.
Lindenaur, Peter K. M. D, et. al., “Public Reporting and Pay for Performance in Hospital Quality Improvement,” New England Journal of Medicine, February, 2007.
Russell, John, et. al, “Pay for Performance-Incentives, Models, Measures and Perspectives,” Managed Care Information Center, Robert Jenkins, publisher, 2006.
“Health Care Leaders Say P4P Programs Will Continue to Expand,” Managed Care Information Center, Pay-For-Performance Newsletter, May, 2008.
Cromwell, Jerry, Ph.D, et. al., “Financial Gains and Risks in Pay-for-Performance Bonus Algorithms”, Health Care Financing Review, Fall 2007.
Shaman, Hindy, Director, Health Industries, Price-Waterhouse-Coopers, “Keeping Score: A Comparison of Pay for Performance Programs Among Commercial Insurers,” powerpoint presentation, Price-Waterhouse-Coopers, 2006.
Baker, Geof, CEO, MedVantage, “Pay for Performance: National Perspective” Leap Frog Group, powerpoint presentation, Jun. 7, 2007.
“2007 National Pay for Performance Study Results with '07 Projections,” Leap Frog Group, MedVantage, powerpoint presentation, 2007.
“P4P in Healthcare Gets an ‘Incomplete’ From Price Waterhouse-Coopers,” downloaded article, Managed Care Information Center, 2008.
D. Blumenthal et al., “Health Information Technology in the United States: The Information Base for Progress”, Robert Wood Johnson Foundation, 2006.
“http://patft.uspto.gov/netacgi/nph-Parser?Sect1=PTO2&Sect2=HITOFF&p=4&u=%2Fnetahtml%2FPTO%2Fsearch-bool.html&r=167&f=G&1=50&col=OR&d=PTXT&s1=%22intelligent+agent %22&s2=%22business+intelligence%22&OS=%22intelligent+agent%22+OR+%22business+intelligence%22&RS=%22intelligent+agent %22+OR+%22business+intelligence%22-h1#h1http://patft.uspto.gov/netacgi/nph-Parser?Sect1=PTO2&Sect2=HITOFF&p=4&u=%2Fnetahtml%2FPTO%2Fsearch-bool.html&r=167&f=G&1=50&col=OR&d=PTXT&s1=%22intelligent+agent%22&s2=%22business+intelligence%22&OS=%22intelligent+agent%22+OR+%22business+intelligence%22&RS=%22intelligent+agent%22+OR+%22business+intelligence%22-h3#h3Business Intelligence Software: Engendering a Quiet Revolution in the Business Place”, MicroStrategy, Dec. 20, 2002
“Middleware—The Essential Component for Enterprise Client/Server Applications”, International Systems Group, Inc., February 1997
Ballesteros, L. and W. B. Croft, “Phrasal Translation and Query Expansion Techniques for Cross-Language Information Retrieval”, Proceedings of the 20th Annual International ACM SIGIR Conference on Research and Development in Information Retrieval, 1997, pp. 84-89.

### FIELD OF THE INVENTION

The present invention relates generally to electronic medical records and, more particularly, to an improved electronic health management system which includes methodology that facilitates interactions among patients, physicians and health insurance providers for a variety of different purposes, including more proactive health care programs benefiting patients as well as physicians and care givers.

### BACKGROUND OF THE INVENTION

According to the National Institutes of Health, more than 14% of the gross domestic product of the U.S. is spent on health care. Analyst firm Price Waterhouse-Coopers notes that as of 2007, the U.S. ranks lowest of developed nations in life expectancy and infant mortality, and only 55% of the U.S. population receives recommended medical care. Additionally, the firm notes that between 44-98,000 people die annually from preventable medical errors, and the average hospital patient experiences at least one medical error daily. Clearly, there is a need for technology as evidenced in the present invention, to fill in the treatment gaps and to prevent errors wherever possible.

Another analyst group, Accenture, has stated: “medicine has lagged significantly behind most other fields in the type of data awareness and evidence based feedback by which other industries live and die.” The U.S. President, George Bush, said in April, 2004 that his Administration established a goal that electronic medical records and electronic health records be universally adopted by the year 2010.

The Department of Health and Human Services, National Institutes of Health, states on its website: “The health care ‘system’ in America is not a system. It's a disconnected collection of large and small medical businesses, health care professionals, treatment centers, hospitals, and all who provide support for them. Each player may have its own internal structure for gathering and sharing information, but nothing ties those isolated structures into an interoperable national system capable of making information easily shared and compare.” The present invention may be one component that could lead to an interoperable national system which the U.S. government, though the NIH agency, clearly states as a national need. www.nih.gov/valuedriven.

### DESCRIPTION OF THE RELATED TECHNOLOGY

Electronic medical records, EMR, and electronic health records, EHR, have begun to be used more extensively by physicians and hospitals since the year 2000. EMRs and EHRs seek to replace paper records of patients, physicians, hospitals and the like, and to make the data available on an as-needed basis by health care providers, health care payers, as well as patients, in compliance with the 1996 Health Insurance Portability and Accountability Act (HIPAA).

Early examples of EMRs include the record system taught by Myers, et. al, U.S. Pat. No. 5,832,450 (Nov. 1998) wherein the system stored data about patient encounters arising from a content generator in free form text. The present invention aggregates all data related to clinical activity, whether in free form text or in any image, digital or digitally scannable, and is thus not, in itself, a system or method of creating an electronic medical or health record.

A method of generating medical information, including quantitative and image data is taught by Fallon, et. al. in U.S. Pat. No. 7,283,857 (Oct. 2007) wherein the generating of said data is based on the performed acquisition and construction of a DICOM compatible file. The present invention does not depend on a DICOM compatible file but instead comprises a mechanism to aggregate DICOM and other compatible files, and does not employ Fallon's mechanism of generating quantitative data.

On teaches a medical record management system in U.S. Pat. No. 7,321,861 (Jan. 2008) in which (a) a data receiver selectively receives one or more medical files pertaining to a first patient, (b) a recorder to record and store each file of the patient in terms of “predetermined syntactical and semantic constructs” and (c) a query module to receive a query from a predefined source. The present invention does not rely exclusively on predetermined syntactical and semantic constructs” or any particular medical scripting language, and is thus more inclusive in it ability to aggregate medical data, including but not limited to clinical activity of all types.

A method, system and storage medium for providing web based electronic research and presentation functions through a document creation application is taught by Kelley, et. al. in U.S. Pat. No. 7,401,068 (July 2008) whereby the method comprises scanning active documents and searching databases based on keywords. In the instant invention, active and inactive documents alike can be edited and aggregated at the same time and the process software of the present invention, and all of the software the present invention will integrate and aggregate is converted, where applicable, to extensible markup language, XML, and unlike the Kelley method, is not required to be “deployed by manually loading the process software directly into the client . . . .”

### SUMMARY OF THE INVENTION

In one embodiment, a method of encouraging the use of generic drugs comprises maintaining a database of (1) prescribed branded drugs by patient and health care provider, (2) generic drugs that can be substituted for identified branded drugs, (3) actual substitutions of the generic drug for the prescribed branded drug by a health care provider, (4) discrete and disparate medical data regarding branded and generic drugs, and (5) incentives available to substitute the generic drug for the prescribed branded drug, and delivering to at least certain of the health care providers an incentive to substitute the generic drug for the prescribed branded drug. One implementation of this method also requests agreement by the health care provider to substitute an identified generic drug for a prescribed branded drug, for use by the patient, and communicates to the patient (1) the availability of the generic drug as a substitute for the prescribed branded drug and (2) the agreement by the health care provider to such substitution.

In another embodiment, a method of encouraging the use of a health care program recommended to a patient by a health care provider, comprises maintaining a database of recommended health care actions by patient and health care provider; maintaining a database of recommended changes in recommended health care actions by patient and health care provider; requesting agreement by a health care provider to the recommended changes for at least one patient of that provider, and communicating to that patient (1) the recommended changes and (2) the agreement by the health care provider to such recommended changes; maintaining a database of actual changes in recommended health care actions by health care provider; and delivering to at least certain of the health care providers an incentive to recommend health care actions that include the recommended changes. The recommended health care actions may include a plurality of plans selected from the group consisting of asthma treatment plans, cigarette cessation plans, and plans for compliance with screening for cervical cancer, breast cancer, colon cancer, diabetes, cholesterol, childhood immunization programs, mammogram programs and prescribed medications.

In a further embodiment, a method of supplying electronic prenatal records to hospitals comprises collecting prenatal records for patients, each prenatal record and associated medical data including at least laboratory test results, ultrasound results, recommended medications, doctor visit dates and a medical history of the patient; requesting agreement by health care providers of the patients to the collection and maintenance of the prenatal records; maintaining the prenatal records at a network site accessible by authorized health care providers; maintaining a record of the instances of accessing of the prenatal records on the network site by each of the authorized health care providers; and charging the authorized health care providers for accessing the prenatal records on the network site, based on the number of instances of accessing the records maintained in the database, and includes compilations of the types of information accessed in the prenatal records and associated medical data on the network site, without identifications of patients or health care providers, and selling the compilations to those authorized to view the compilations of records and said medical data.

### BRIEF DESCRIPTION OF THE DRAWINGS

The invention may best be understood by reference to the following description taken in conjunction with the accompanying drawings, in which:

FIG. 1. is a screen shot of the home page of an electronic health management system accessible to authorized users on the internet and utilizing one embodiment of the invention.

FIG. 1A is a diagram of a system for aggregating, integrating and reporting information, records and medical data before and during the viewing on the home page of FIG. 1.

FIG. 2 is a screen shot of the first page displayed to an authorized user who logs on to the system via the home page in FIG. 1.

FIG. 3 is a screen shot displaying the drop down menu of the “From” field in FIG. 2.

FIG. 4 is a screen shot of the page displayed when the user selects the “Brand Drug (based on script)” option in the drop down menu in FIG. 3.

FIG. 4A is a diagram of a system that enables an authorized user to accesses a drug record database resulting in the “Brand Drug (based on script)” of FIG. 4, along with other databases such as hospital records, prenatal records, laboratory records, insurance providers claims, prescription drug records, and quality of care, pay for performance indicators.

FIG. 5 is a screen shot of the page displayed when the user selects the first “Action” icon in FIG. 4, “View by Provider.”

FIG. 6 is a screen shot of the page displayed when the user selects the first “Action” icon in FIG. 5, “Write Letter.”

FIG. 7 is a screen shot of the page depicted in FIG. 6 with the pull-down menu options displayed.

FIG. 8 is a screen shot of the page displayed when an option from the menu in FIG. 6 has been selected and a letter generated.

FIG. 9 is a screen shot of the page displayed when the “New Letter Template” link below the menu box in FIG. 6 is clicked.

FIG. 10 is a screen shot of the page displayed when the second “Action” icon in FIG. 4, “View by Detail,” is selected.

FIG. 11 is a screen shot of the page displayed when the third “Action” icon in FIG. 4, “Write Letter,” is selected. The pull-down menu lists the same options as the one in FIG. 7.

FIG. 12 is a screen shot of the page displayed when the “Custom” options under the heading “Reports” in the frame on the left-hand side is selected.

FIG. 13 is a screen shot of the page displayed when the “New Report” option from the page depicted in FIG. 12 is selected, with the pull-down menu listing options of databases to query.

FIG. 14 is a screen shot of the page displayed when a database from the menu in FIG. 13 is selected.

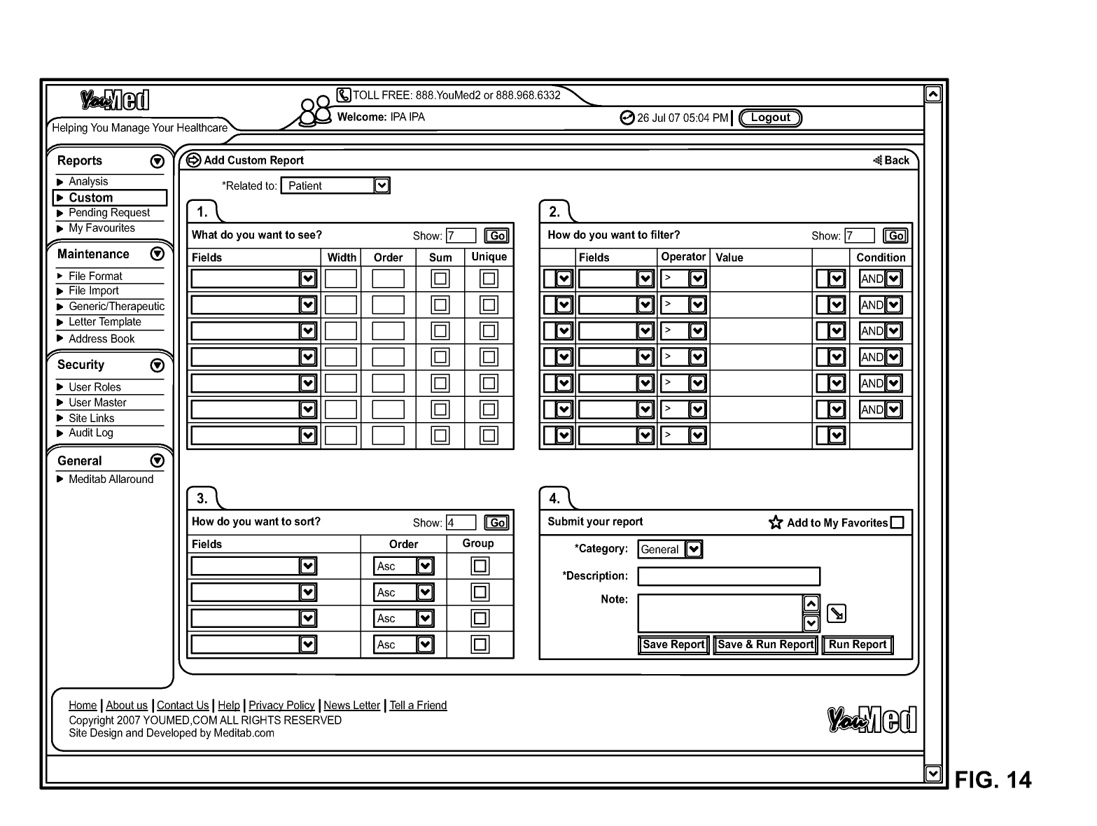

FIG. 15 is a screen shot of the page displayed when the report “Asthma Action Plan” from the list in FIG. 12 is selected and the “Claims” database is being queried.

FIG. 16 is a screen shot of the page in FIG. 15 with the pull-down menu from one of the fields displayed.

FIG. 17 is a screen shot of the page in FIG. 15 with the remaining portion of the pull-down menu from FIG. 16 displayed.

FIG. 18 is a screen shot of the page displayed when the report “Drill Down on RX Data” from the list in FIG. 12 is selected and the “Prescription” database is being queried.

FIG. 19 is a screen shot of the page in FIG. 18 with the pull-down menu from one of the fields displayed.

FIG. 19A is a diagram and drawing of a system that enables an authorized user to access information in the fields displayed in FIG. 19, such as databases related to known patients, prescription drug records, hospital records, prenatal care records and actions recommended, laboratory records, insurance provider claims and incentive indicators, and quality of care and pay for performance indicator.

FIG. 20 is a screen shot of the page in FIG. 18 with the remaining portion of the pull-down menu from FIG. 19 displayed.

FIG. 21 is a screen shot of the page displayed when the report “Lab Drilldown” from the list in FIG. 12 is selected and the “Lab” database is being queried.

FIG. 22 is a screen shot of the page in FIG. 21 with the pull-down menu from one of the fields displayed.

FIG. 23 is a screen shot of the page in FIG. 21 with the remaining portion of the pull-down menu from FIG. 22 displayed.

FIG. 24 is a screen shot of the page displayed when the user selects “Pending Requests” after selecting “Custom.”

FIG. 25 is a screen shot of the page displayed when the report “Provider List” from the list in FIG. 12 is selected and the “Provider” database is being queried.

FIG. 26 is a screen shot of the page in FIG. 25 with the pull-down menu from one of the fields displayed.

FIG. 27 is a screen shot of the page displayed when the option “My Favorites” under the heading “Reports” from the frame on the left-hand side is selected.

FIG. 28 is a screen shot of the page displayed in FIG. 12 with a star displayed next to all the reports that have been marked as “Favorite.”

FIG. 29 is a screen shot of the page displayed when the option “Letter Template” under the heading “Maintenance” from the frame on the left-hand side has been selected.

FIG. 30 is a screen shot of the page displayed when the template “Asthma Patient Follow-up Letter” has been selected from the options listed in FIG. 28.

FIG. 31 is a screen shot of the page displayed when the template “PT Follow-up re: no RX” has been selected from the options listed in FIG. 28.

FIG. 32 is a screen shot of the page displayed when the template “RX Brand Target Letter” has been selected from the options listed in FIG. 28.

FIG. 33 is a screen shot of the page displayed when the option “Address Book” under the heading “Maintenance” from the frame on the left-hand side has been selected.

FIG. 34 is a screen shot of the page in FIG. 33 after information has been entered in the blank fields.

FIG. 35 is a screen shot of the page displayed when information entered into the fields in FIG. 33 has been saved.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

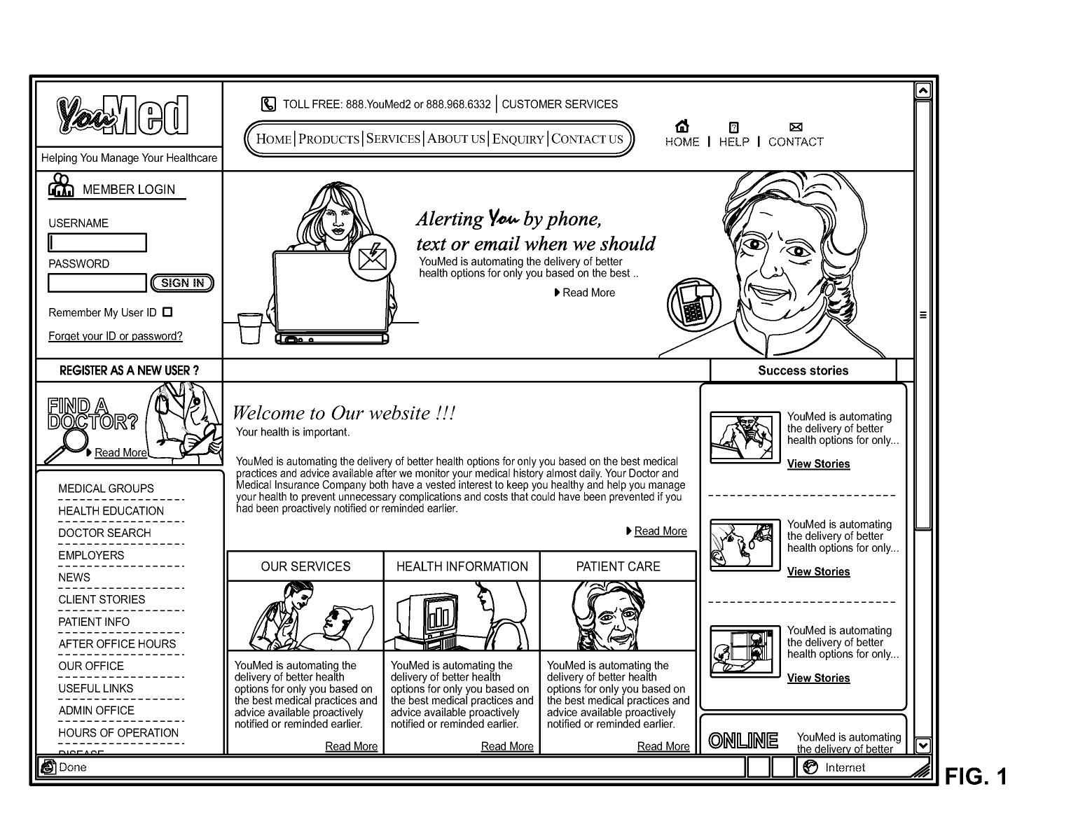

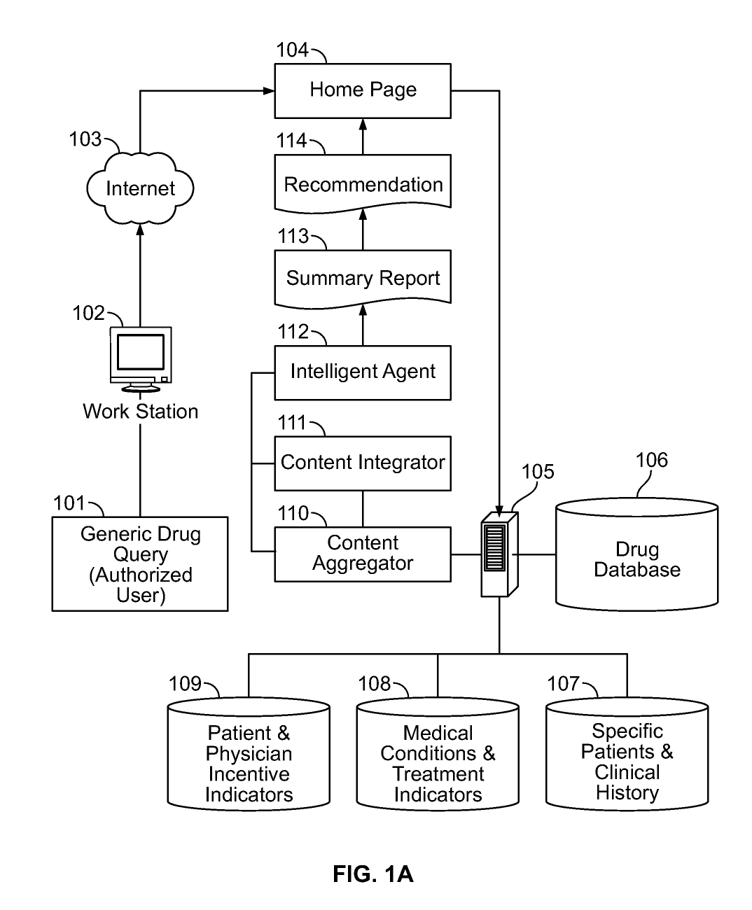

Turning now to the drawings, FIG. 1 is a screen shot of the home page of the web site that can be accessed via the internet and used by authorized users to log onto an electronic health management system.

FIG. 1A is a diagram of a system that enables a physician or other authorized user 101 to access a home page 104 (shown in FIG. 1) by querying through a workstation 102 coupled to the home page via the Internet 103. The home page 104 is also coupled to a server 105, which in turn is coupled to a database 106 containing information regarding drug treatments with generic vs. branded drugs, a data bases 107, containing information on specific patients and their clinical activities and history, a database 108 containing specific medical conditions and their treatment indicators, including but not limited to drug therapies, and a database 109 of specific patient and physician incentive indicators. The server 105 is also coupled to a content aggregator 110 programmed to aggregate medical data from the databases 106-109 and to supply the aggregated data to a content integrator 111. The content integrator 111 assembles and integrates discrete and disparate data and images, as well as text and other media such as audio and video. The content integrator 111 and content aggregator 110 are coupled to an intelligent agent 112 that is activated by a generic drug query originated by the user 101 and transmitted to the server 105 via the workstation 102 and the Internet 103. The intelligent agent 112 derives and analyzes the information from the databases 106-109 to generate a summary report 113 and a recommendation 114 regarding the generic drug query, viewable on the home page 104 by the said authorized user.

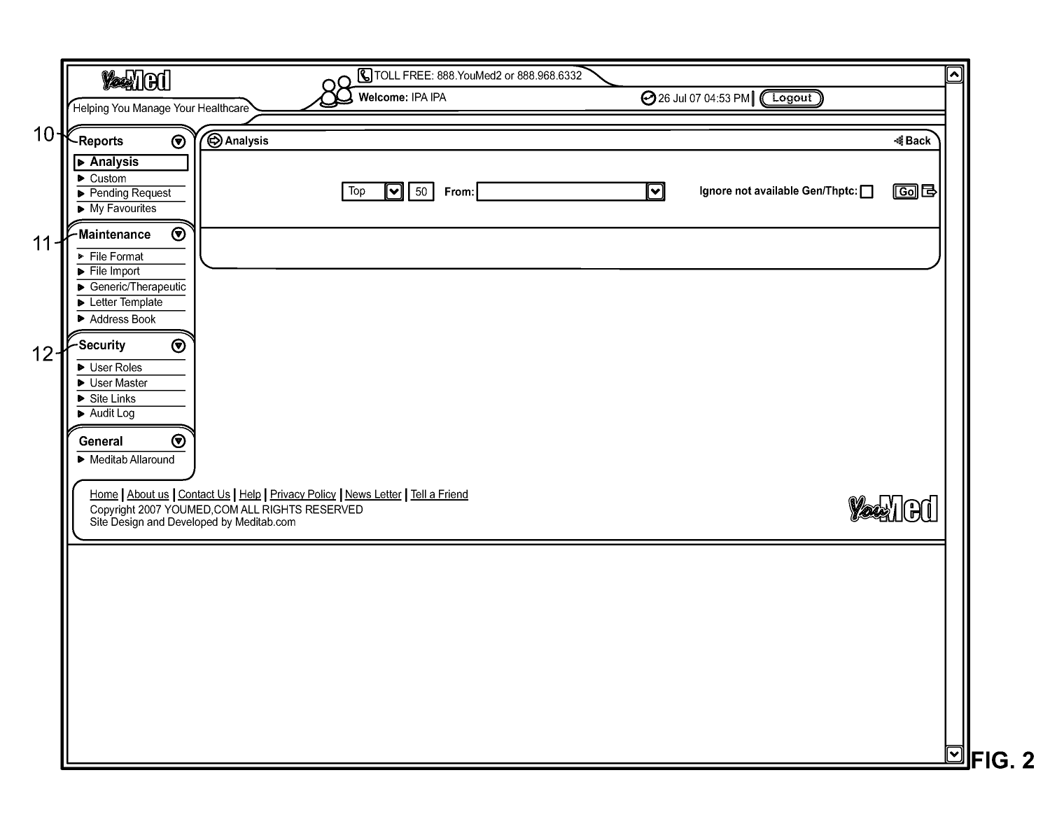

FIG. 2 is a screen shot of the first page displayed to a user who has logged onto the system. Three headings, “Reports” 10, “Maintenance” 11 and “Security” 12, appear along the left side of the page, and beneath each of these headings is a list of options that can be selected by the user by clicking on them. The options are:

Reports
Analysis—taking multiple fields of data across the user group and for example lists the TOP 10 prescribed drugs by script (each prescription written) or Top 50 ICD codes in terms of claims in descending order.
Custom—Reports that can be run in minutes from data. Thousands of variations off of each user group.
Pending—Report yet to run that tells us (Master Users/Developers of software) what combination of variables were attempted and by whom.
My Favorites—Saved reports that can be run again at later dates.

Maintenance
File Format—Excel or CSV choice of spreadsheets.
File Import—Raw data sources listed by date and what of on site per user group.
Generic/Therapeutic—An electronic “formulary” that can convert branded drugs to generic alternatives with query capability. Can convert text. Name drug to NDC code and vice versa.
Letter template—An automatic letter writing application inside the site that can generate letters to a large database of patients and addresses for 100's of (medical) actions.
Address Book—Storage of addresses per user group and not to be shared or seen by other groups because the databases are partitioned from one another.

Security
User roles—Definitions of access, add and delete roles, filter data fields per role granted or deleted.
Master roles—Defines providers and what they can access.
Site Links—Favorite site links that can be stored.
Audit log—Who logged on and when.
Meditab all around—Meditab link or URL

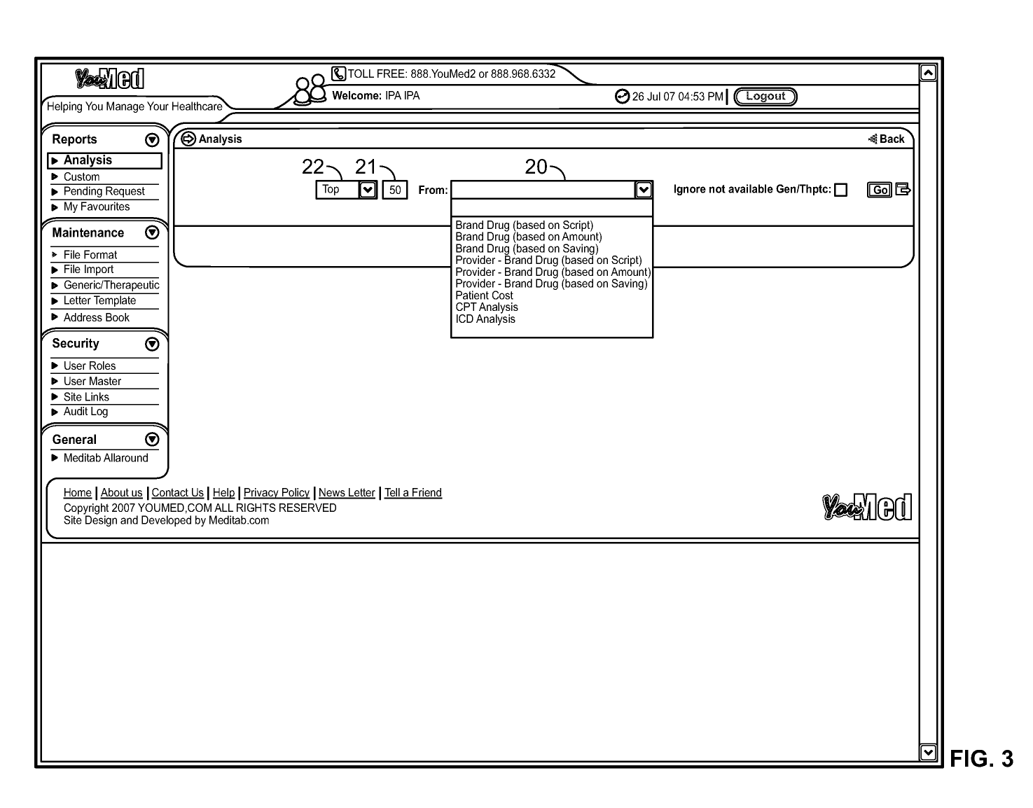

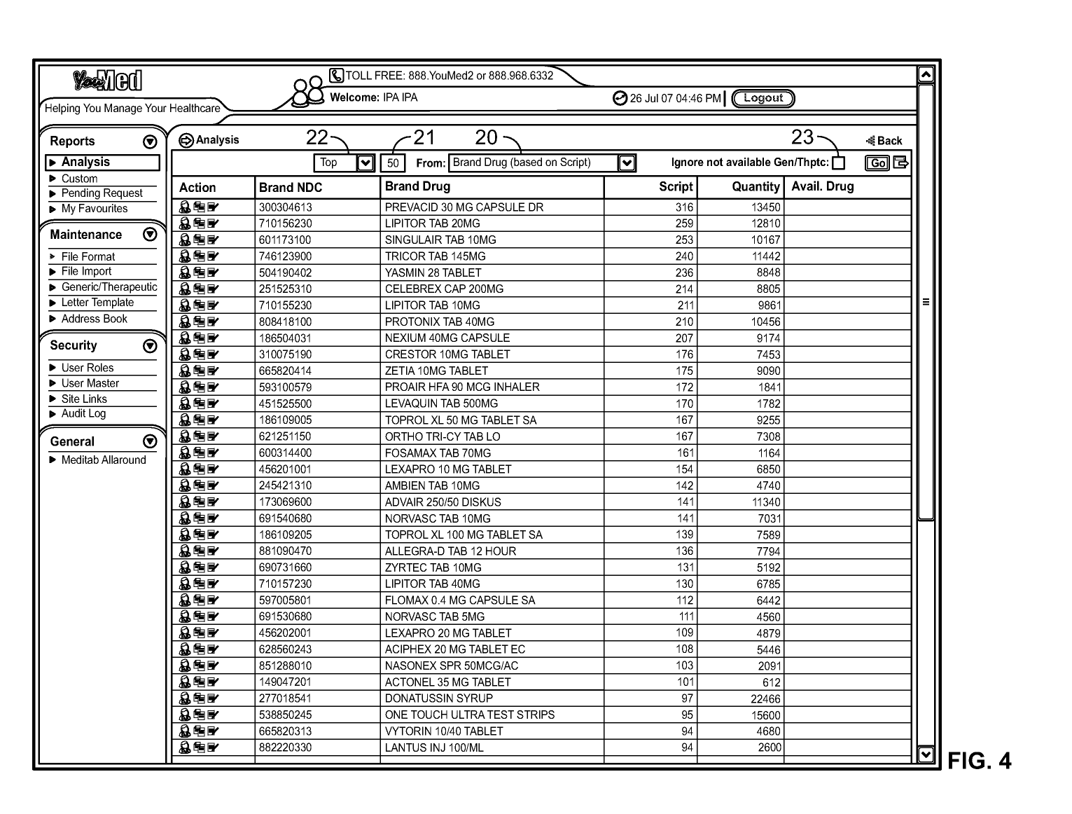

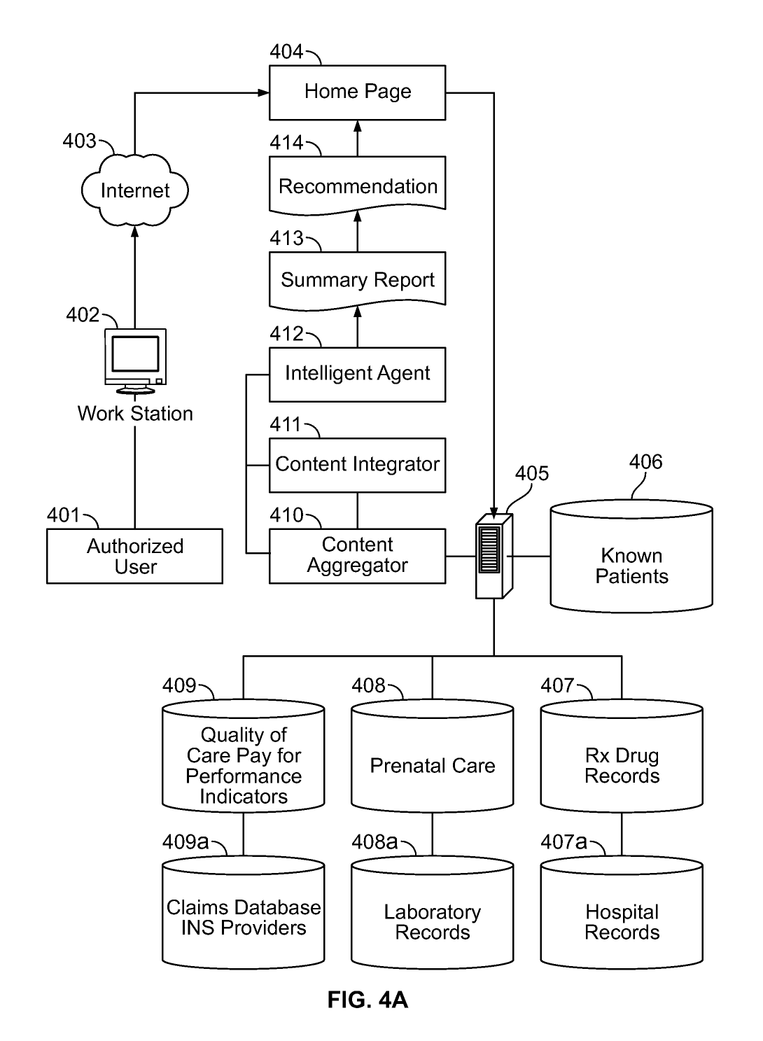

When the “Analysis” option is selected, the page depicted by the screen shot in FIG. 2 is displayed. FIG. 3 is a screen shot of the page shown in FIG. 2 with the pull-down menu displayed for the box 20 labeled “From:”. Selecting any one of the options in this menu will sort and display the stored data according to the option selected, such as the page depicted by the screen shot in FIG. 4.

The stored data is contained in a database that is preferably a composite of multiple databases that have existed separately, such as an electronic medical records (“EMR”) database for a known population of patients, a prescription drug records database, a prenatal care database, a hospital records database for at least the patients in the EMR database, claims databases from health insurance providers for at least the patients in the EMR database, a laboratory records database for at least the patients in the EMR database, etc. As will be described below, the electronic health management system queries all these components of the master database simultaneously to generate various types of reports requested by the users of the system. Different types of users will be identified when they log onto the system, and will have access to different portions of the master database. For example, a patient will have access only to his or her own records, a physician will have access only to records of his or her own patients, physician associations such as Independent Physicians Associations (“IPA's”) will have access only to records of patients of the physicians in that association, an insurance provider will have access only to records of customers of that company, etc. The system automatically confines each individual user to those portions of the master database that the user is authorized to access.

The master database is constantly updated by the addition and updating of all the components of the database. The web site or portal can be used to search for and retrieve specified subsets of information from the database, as will be discussed below and illustrated in the drawings. Certain components of the database must include the endorsement or recommendation of the applicable health care provider, so that those components can be used to advise the patients of that provider how to improve their health care, or how to control the cost of their health care. For example, when the use of a generic drug in place of a prescribed branded drug is recommended to a particular patient, the use of the generic drug must be approved by the health care provider for that patient. The same is true for recommended health care action plans, such as obtaining mammograms at specified intervals, for example.

The web site or portal can be used to facilitate communications of information from the master database, and/or recommendations or incentives based on that information, to specific patients and/or health care providers. These communications can be by letters, email, text or SMS messages, prerecorded telephone messages, etc. For example, a patient can be advised to have a prescription filled when the database reveals that a prescription given to that patient has, in fact, not been filled within a prescribed time period after the prescription date. Similar communications can be generated for various types of laboratory tests, diagnostic procedures, consultations and the like. A physician can be advised when the database reveals that he or she has prescribed branded drugs that have generic substitutes for specific diseases or conditions identified in the database for specific patients of that physician, and incentives can be communicated to the physician for prescribing such generic drugs in order to reduce the cost of health care for those patients.

Authorized users can be charged for accessing the master database via the network site or portal, based on the number of instances of accessing the database by each authorized user. For example, the master database can include prenatal care records including at least laboratory test results, ultrasound results, recommended medications, doctor visit dates and a medical history of the patient, and then authorized health care providers can be charged for accessing those prenatal records on the network site, based on the number of instances of accessing the records by each accessing health care provider.

Incentives can also be provided for using the master database, and the accessing network site or portal. For example, when a claim for payment for medical treatment of a patient is submitted to an insurance company of other paying provider, an extra incentive payment can be made if it is determined that the database was used for the patient identified in the claim.

This system can be used to allow appropriate “free” access to patient's electronic medical records and appropriate “free” access to patient's digitized paper medical records. The physician may not be required to directly pay anything for the access to the information, just to have access to the internet. The system may also allow an incremental adoption from an operational point of view for the providers, staff of providers and patients of the use and the incremental use of the features of the electronic sources of data. Further, the incremental adoption may be incentivized to the provider and patient by the payer.

In the illustrated example in FIG. 4, the option selected is “Brand Drug (based on Script),” thus displaying the data according to the number of prescriptions filled. Another available option is “Brand Drug (based on Saving),” which displays the data according to the savings realized by substituting a generic drug for the branded drug.

Box 21, to the left of box 20 in FIG. 3, allows the user to input a number for the amount of search results the system should display per page, and box 22, to the left of box 21, permits the user to display either the top or bottom number of search results specified in box 21. In the example shown in FIG. 4, the number entered in box 21 is “50,” and thus only 50 brand drugs are displayed. Also, the option selected in box 22 is “Top,” thus displaying the top 50 brand drugs ranked according to the number of prescriptions written for each drug for the patient population and time period covered by the existing database.

Box 23 in the “Analysis” frame can be checked by the user when it is desired to ignore branded drugs for which there is no generic alternative.

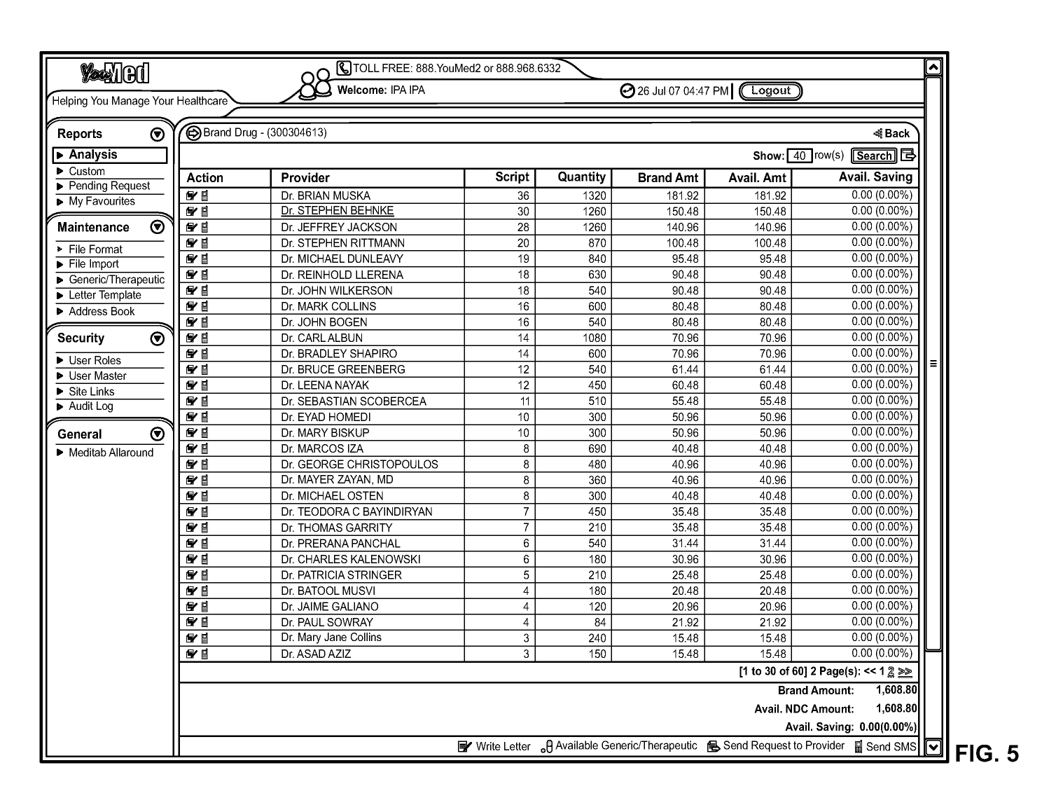

On the left hand side of the page depicted in FIG. 4, three icons are displayed under the heading “Action,” each allowing the user to perform a specific task: the icon of a person allows the user to “View by Provider,” the icon of two pages allows the user to “View by Detail,” and the icon of a pen on paper allows the user to “Write Letter.” Clicking the “View by Provider” icon brings up the page depicted in FIG. 5. Selection of this icon sorts and displays all the brand drugs by provider name.

FIG. 4A depicts a system that enables an authorized user to perform a specific task leading to the screen shots of FIGS. 4 and 5. An authorized user 401 can access a home page 404 by querying through a workstation 402 coupled to the home page via the Internet 403. The home page 404 is also coupled to a server 405, which in turn is coupled to databases 406-409 and 407a-409a. The “known patient” database 406 includes records associated with the patients, and the database 407 includes information regarding generic and branded drugs. An authorized user such as a physician, hospital or insurance provider, can review clinical activity and actions, including laboratory records in database 408a, hospital records in database 407a, prenatal care records in database 408, and insurance claims in database 409a. For example, the user can click on “View by Provider” in FIG. 4 to access the databases for data that is aggregated by a content aggregator 410, integrated by a content integrator 411, and summarized by an intelligent agent 412 into a summary report 413 and a recommendation 414. FIG. 4A illustrates a system that enables querying by the authorized user 401, actions able to be viewed as history on the homepage 404 and subsequent screen shots such as FIGS. 4 and 5, and actions initiated by the process of viewing information from the various databases illustrated in FIG. 1A and FIG. 4A, summary reports 113 and 413, and recommendations, 114 and 414. The authorized user may also communicate with a patient, another physician or hospital, or another authorized user. Of particular interest to insurance providers, physicians or hospitals is the database 409 regarding quality of care and pay for performance indicators, and the claims database 409a, which may result in an extra payment or other incentives for a care provider.

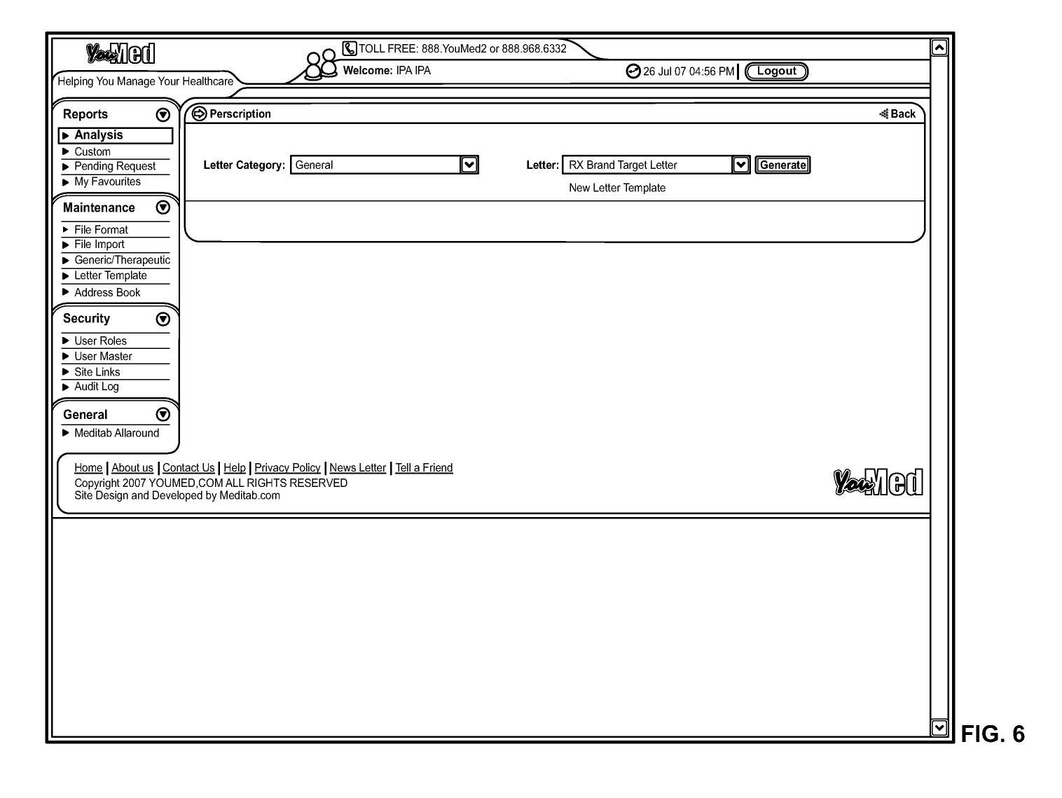

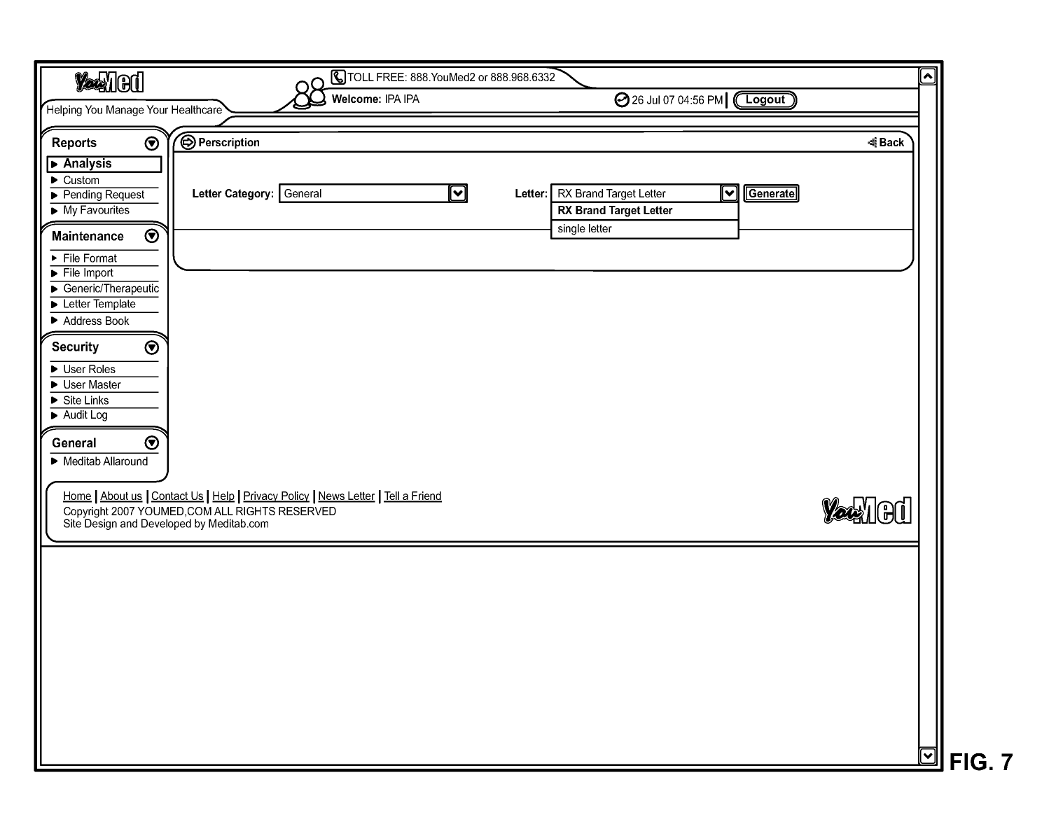

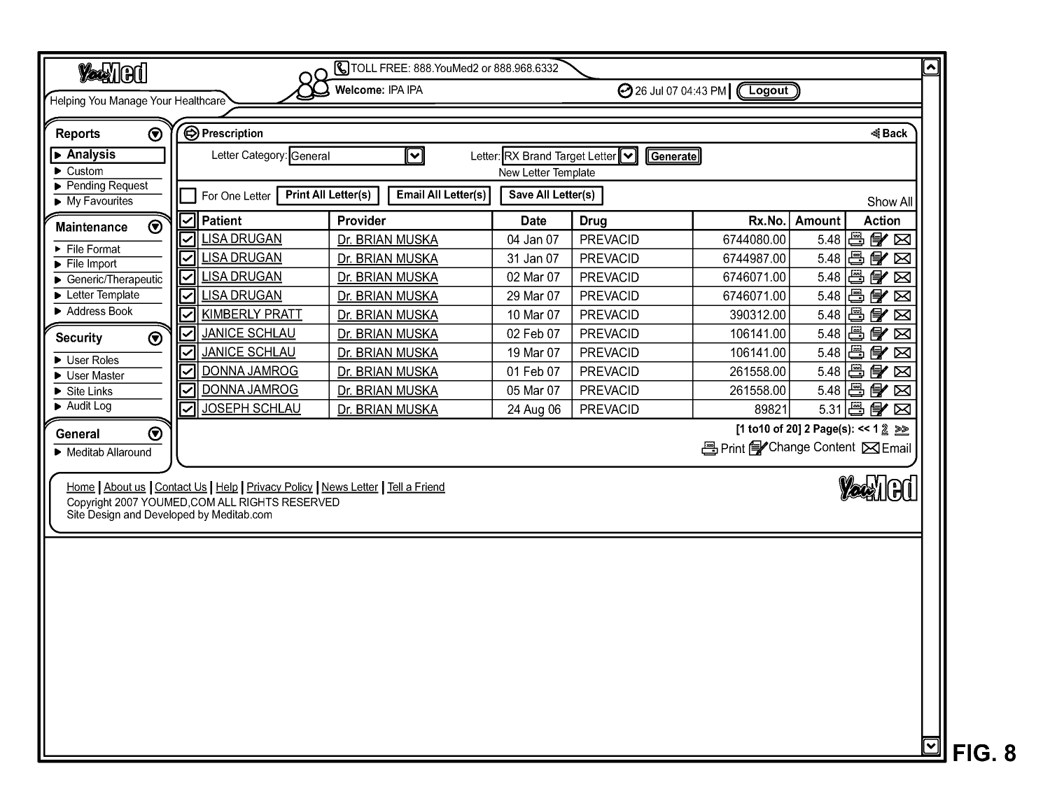

On the page depicted by the screen shot in FIG. 5, two further actions under the heading “Action” can be taken, depicted by the “Write Letter” icon and the phone icon, which allows users to send an SMS message. Selecting the “Write Letter” icon brings up the page depicted by the screen shot in FIG. 6. FIG. 7 is a screen shot of the page depicted in FIG. 6 with the pull-down menu displayed. Users can choose a letter template option from the menu and then click “Generate.” Generating a letter brings up the page depicted by the screen shot in FIG. 8. This page allows a user to view previous letters that have been sent out by providers.

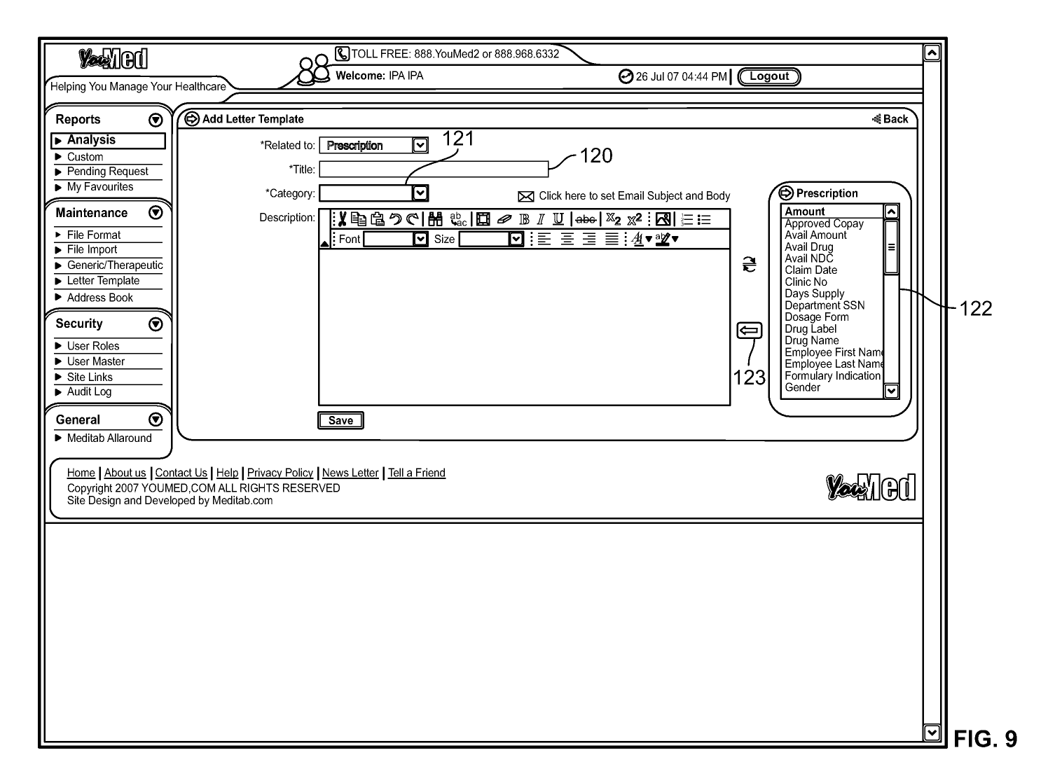

Returning to FIG. 6, clicking on “New Letter Template” will direct the user to the page depicted by the screen shot in FIG. 9. The user can enter a title in the “Title” box 120 and select a category from the “Category” box 121. The “Prescription” box 122 on the right hand side allows the user to input cues for the items listed. Cues can be entered into the description textbox by highlighting the listed option desired and clicking the green arrow 123.

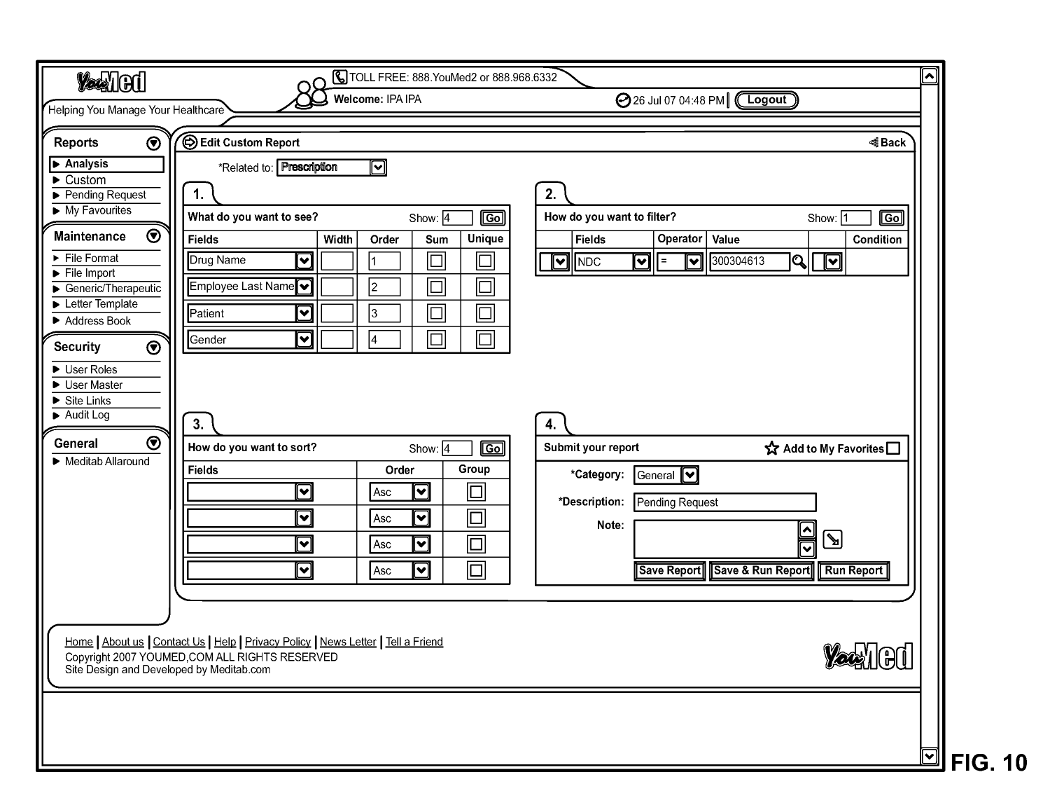

Returning to FIG. 4, selecting the “View by Detail” icon directs the user to the page depicted by the screen shot in FIG. 10, which allows the user to drill down into that particular field of data. This is an alternative route to navigate for specific data, rather than using the “Custom Report” route.

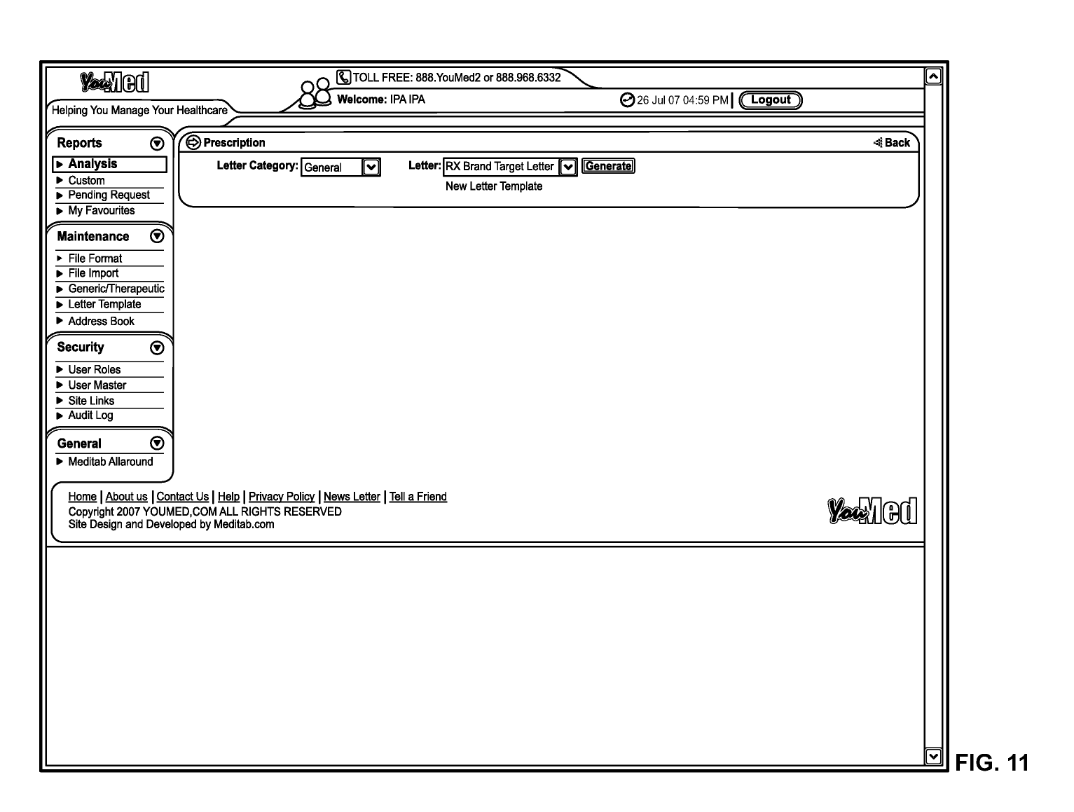

Returning again to FIG. 4, selecting the “Write Letter” icon directs the user to the page depicted by the screen shot in FIG. 11, which allows the user to select and generate a particular letter template relating to that specific drug.

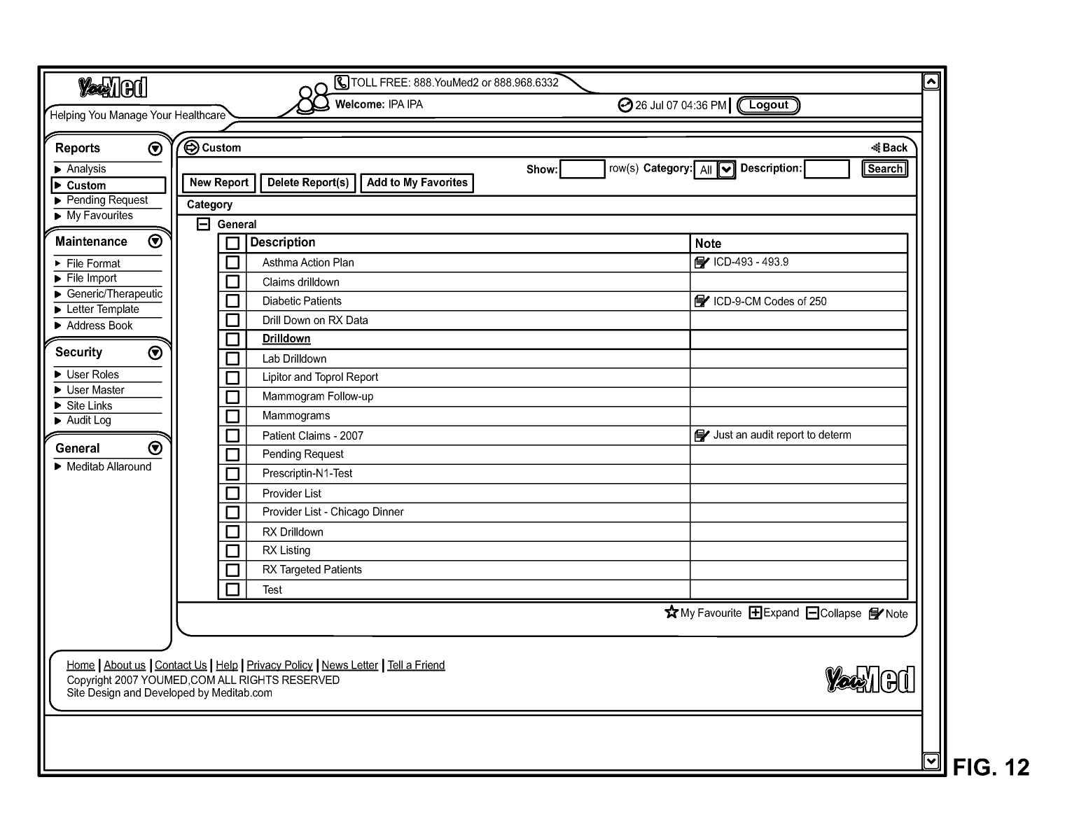

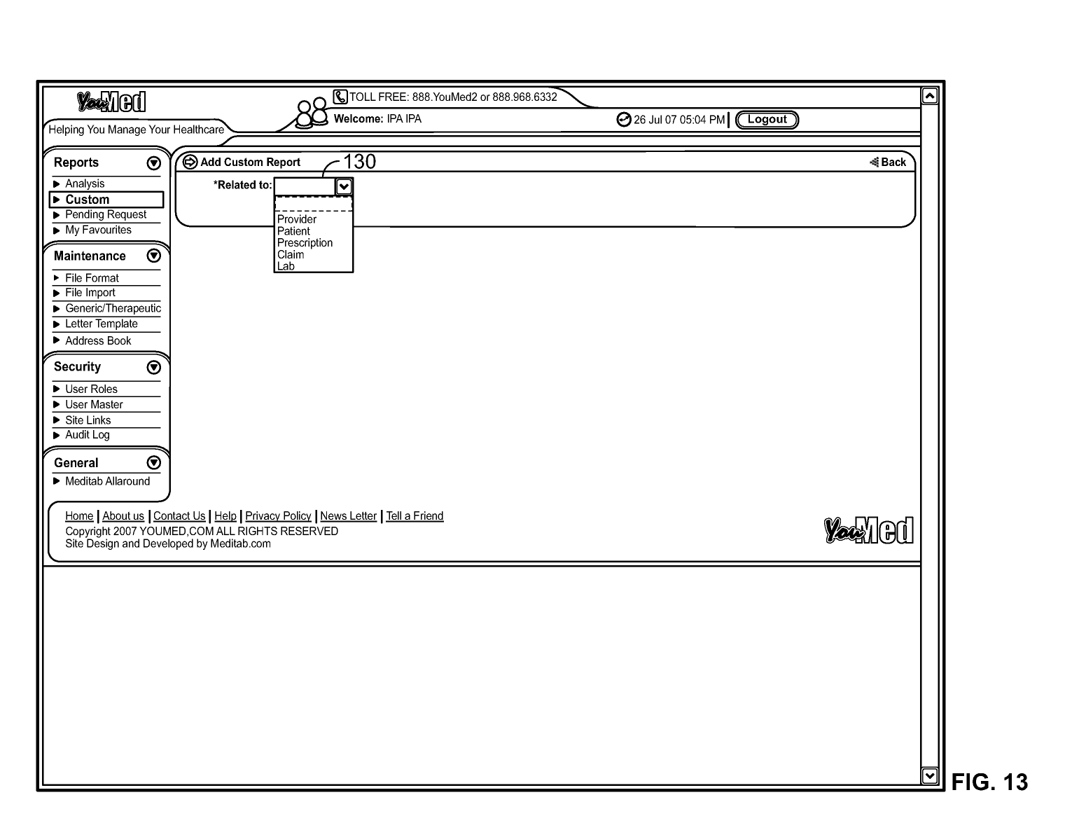

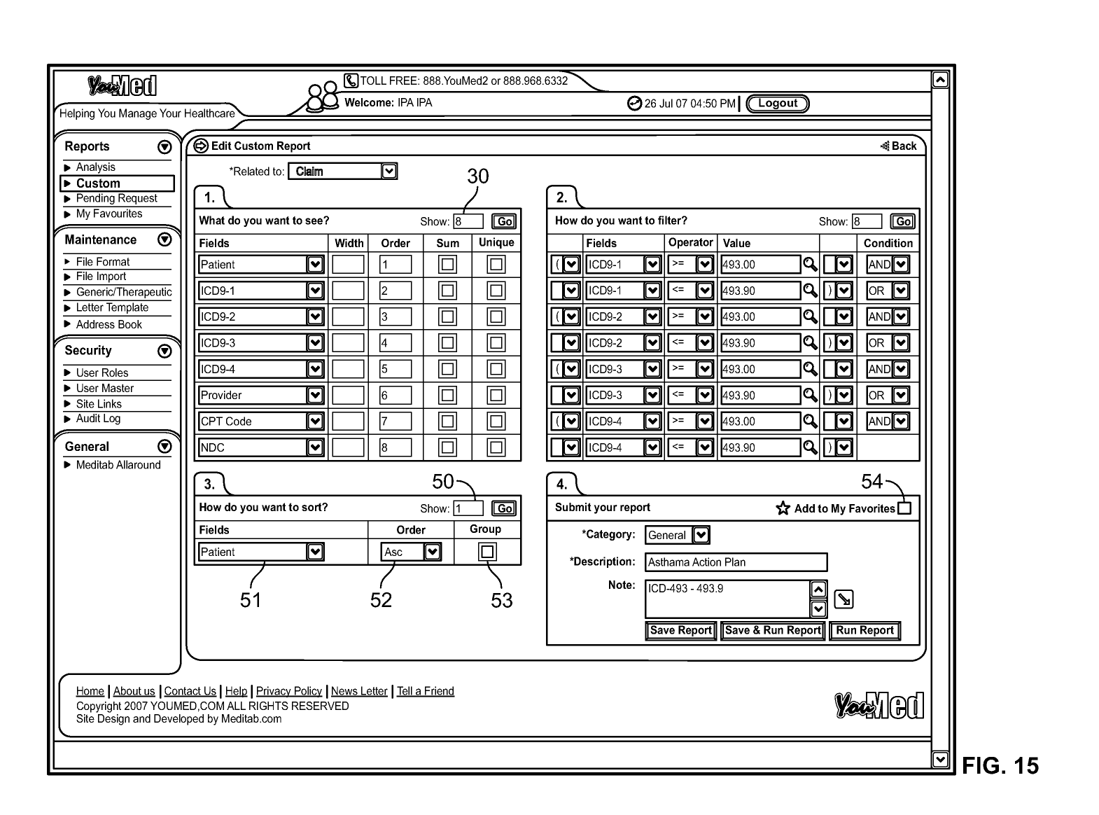

Looking at the frame on the left-hand side, when the “Custom” option under the heading “Reports” is selected, the page depicted by the screen shot in FIG. 12 is displayed, which includes a list of different types of custom report options that can be selected by the user under the heading “Description.” Under the heading “Note,” a document can be opened for certain of the custom report options, to allow each user group to enter notes, e.g., when a provider wants to identify further fields of ICD codes. Clicking the button “New Report” above the heading “Category” will direct the user to the page depicted by the screen shot in FIG. 13. At the top of the page, box 130 adjacent “*Related to:” displays a pull-down menu with a list of databases the user can choose for the report to query. Selecting a database directs the user to an empty formatting page, such as the page depicted by the screen shot in FIG. 15.

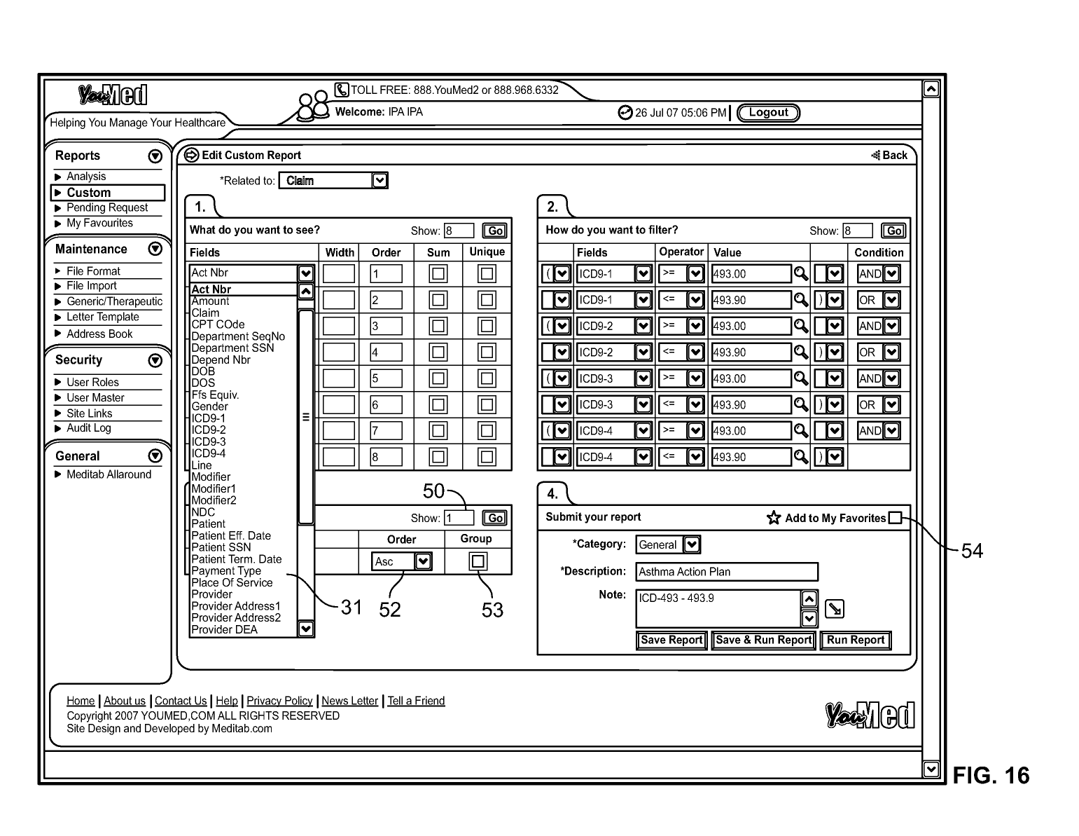

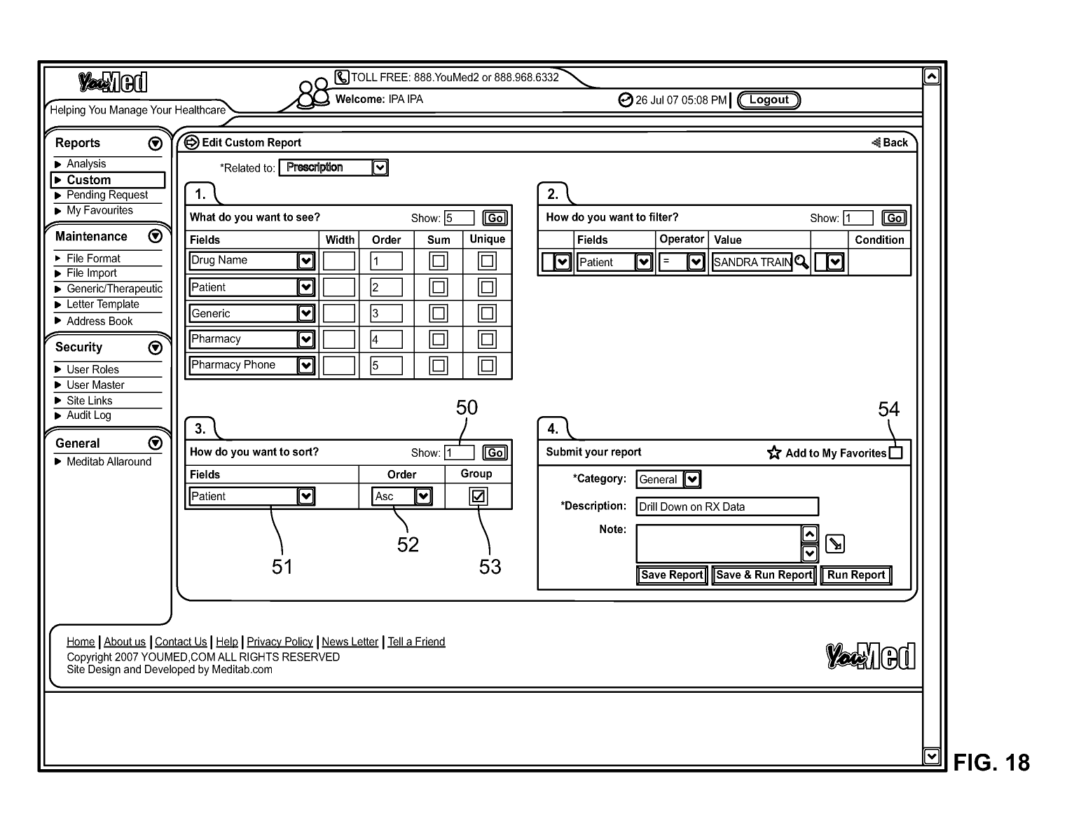

Returning to FIG. 12, clicking any one of the options listed brings up a pre-set formatting page, such as the page depicted by the screen shot in FIG. 15. There are four operations numbered 1 through 4 in the page depicted in FIG. 15. In Operation #1, the user enters a number in a box 30 to set the number of fields to be shown in the query result. In the illustrated example in FIG. 16, the number selected is “8,” and thus eight blank boxes 31-38 are displayed for the user to select the desired field names from pull-down menus. Although the fields are pre-selected to correspond with the particular type of report selected from the list in FIG. 12, they can be modified. The protocols for Operation #1 also apply for the pages depicted in FIGS. 18-26. Any of the four fields “width,” “order,” “sum” and “unique” may be used to specify common variables to be used in the sorting process. In the illustrative example in FIG. 16, the report will display data from the specified fields in the order selected, i.e., first patient, then ICD9-1 data, then ICD9-2 data, and so on.

FIG. 16 is a screen shot of the page shown in FIG. 15 with the pull-down menu of field names displayed for the first box 31. In this particular example, the report option for “Asthma Action Plan” from the list displayed in FIG. 12 has been selected. This report queries the “Claims” database, and 40 available fields are displayed, namely:

Act Nbr

Amount

CPT Code

Depend Nbr

DOB

DOS

Ffs Equiv.

Gender

ICD9-1

ICD9-2

ICD9-3

IDC9-4

Line

Modifier

Modifier 1

Modifier 2

NDC

### Patient

Patient Eff. Date

Patient SSN

Patient Term. Date

Payment Type

Place Of Service

Provider

Provider Address 1

Provider Address 2

Provider DEA

Provider Degree

Provider Id

Provider NPI

Provider Office

Provider Specialty

Provider State

Provider Tax Id

Provider UPIN

Provider Zip

Rev. Code

Type Of Service

Undwtr

Units

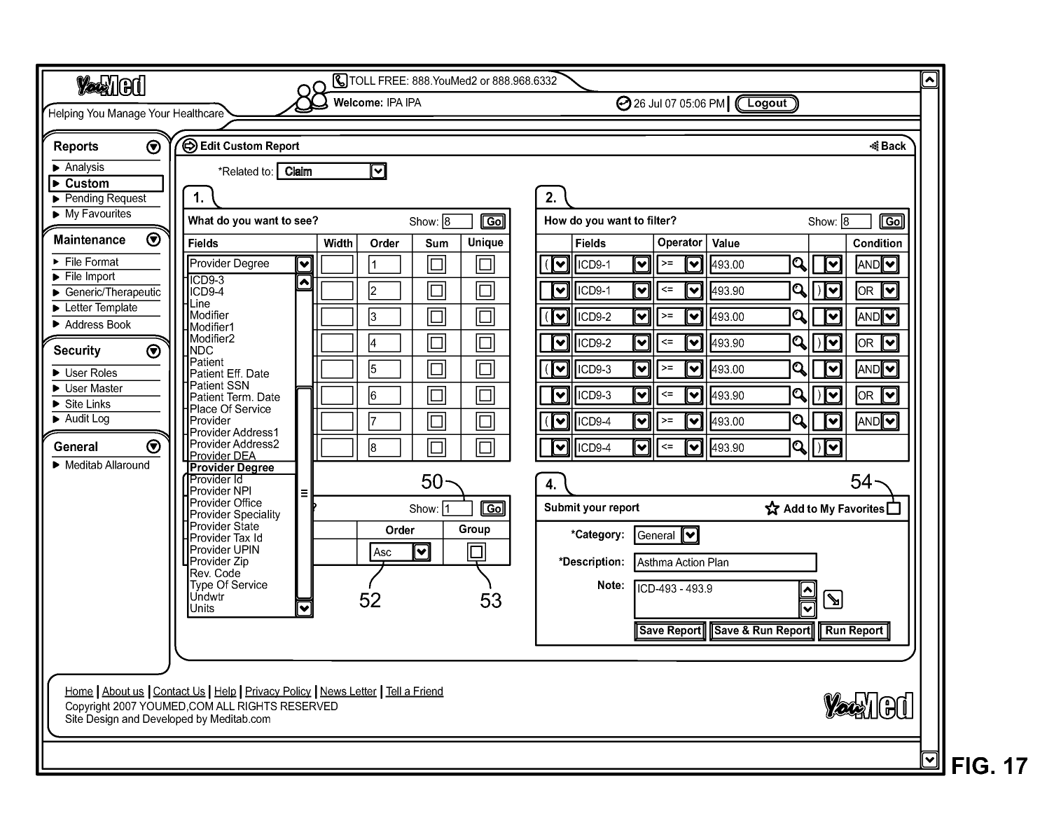

FIG. 17 displays the remainder of the 40 field names from the menu in FIG. 16.

Operation #2 in the page of FIG. 15 enables the user to enter filters for the contents of each of the eight fields selected in operation #1. The protocols for Operation #2 also apply for the pages depicted in FIGS. 18-26. Specifically, the names of the fields to be filtered are selected from the pull-down menus for the boxes under the heading “Fields,” the operators for the desired filtering functions are selected from the pull-down menus for the boxes under the heading “Operator,” the values for the desired filtering functions are entered in the boxes under the heading “Value,” and the Boolean operators for the desired filtering functions are selected from the pull-down menus for the boxes under the heading “Condition.” The pull-down menus to the left of the headings “Fields” and “Condition” are used to input parentheses to separate each filtering line in Operation #2. Clicking on the magnifying glass icon allows users to drill down into the selected data, to provide more granular data in the report. For example, the filtering entries depicted in the example in FIG. 15 will cause the data to be filtered to include only values greater than 493.00 and less than 493.9 for each of the “ICD9-1,” “ICD9-2,” “ICD9-3” and “ICD9-4” fields.

Operation #3 in FIGS. 15-17 enables the user to select the particular order in which the information in selected field(s) to be sorted. The protocols for Operation #3 also apply for the pages depicted in FIGS. 18-26. Specifically, the user selects the number of fields to be displayed for this selection by entering a number in the box 50. In the illustrative example of FIG. 15, the number entered is “1,” and thus only one box 51 is displayed under the heading “Fields.” The user selects the desired field from the pull-down menu for the displayed box 51 (this is the same menu shown in FIG. 16), and then selects the desired order for the contents of that field from the pull-down menu for a box 52 under the heading “Order.” In the illustrative example of FIG. 15, the selected field is “Provider” and the selected order is “Asc,” and thus the provider names will appear in ascending alphabetical order in the “provider” field of the custom report. The box 53 under the heading “Group” can be selected to consolidate all the procedures associated with a particular event, such as a surgery, and display it as simply one event.

Finally, Operation #4 in FIGS. 15-17 identifies the report that has been formatted by the entries in operations #1-#3, and enables the user to “submit” this report by clicking on one of three tabs, namely, “Save Report,” “Save and Run Report” or “Run Report.” The report can be saved as an Excel or CVS file, in the master database and/or in the user's own computer. The box under the “Pending Request” heading informs the user of what report was attempted to be run, and the system operator can review what reports were attempted and attempt to help the user, at a later time. The user may also save this particular report and its format for use with the data available at a future date by clicking on the box 54 adjacent “Add to my Favorites.” The protocols for Operation #4 also apply for the pages depicted in FIGS. 15-17.

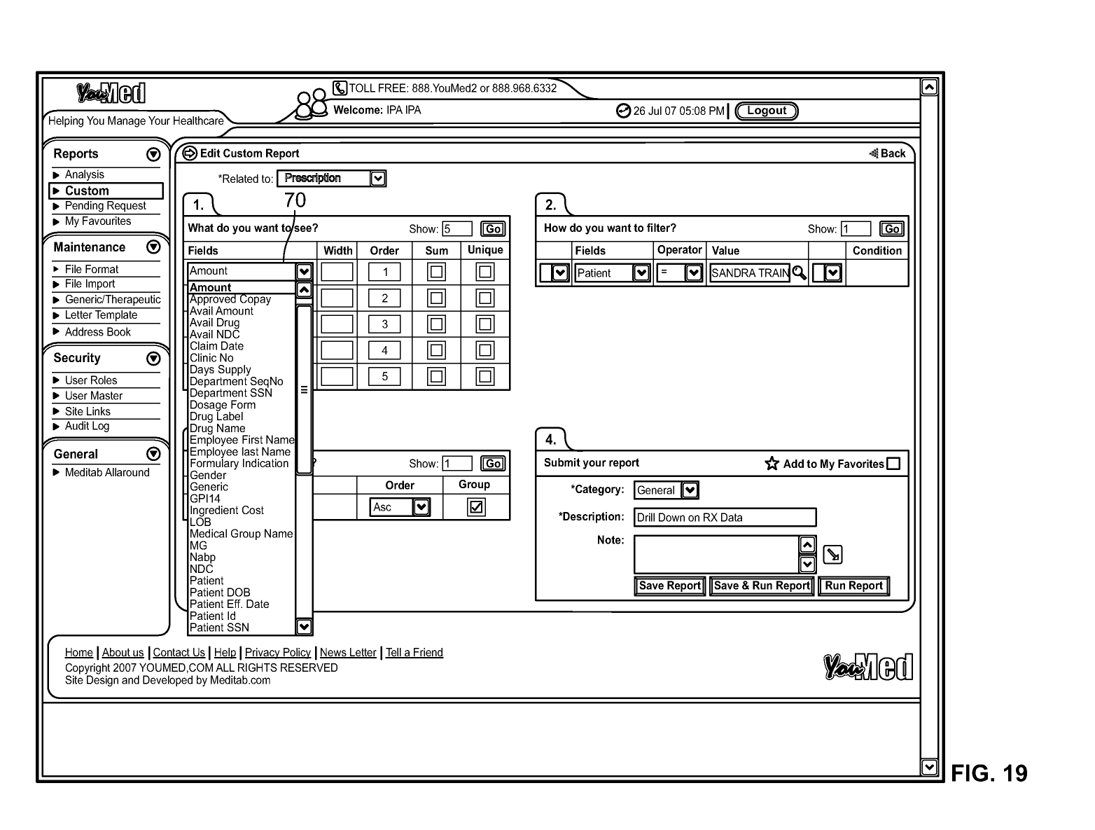

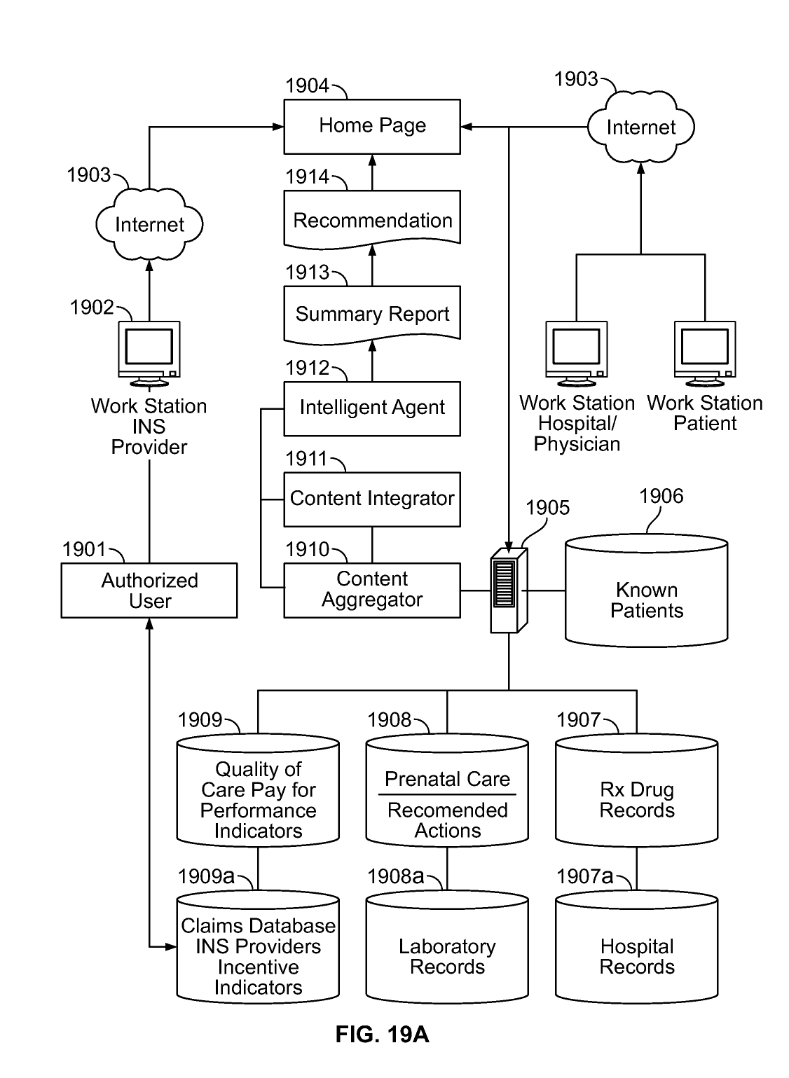

FIG. 19 is a screen shot of the page in FIG. 18 with the pull-down menu of field names displayed for the first box 70 under the heading “Fields.” In this particular example, the report for “Drill Down on RX Data” has been selected from the list displayed in FIG. 12. This report queries the “Prescription” database, and 50 available fields are displayed, namely:

Amount

Approved Copay

Avail Amount

Avail Drug

Avail NDC

Claim Date

Clinic No

Days Supply

Department SeqNo

Dosage Form

Drug Label

Drug Name

Employee First Name

Employee Last Name

Formulary Indication

Gender

Generic

GPI14

Ingredient Cost

LOB

Medical group Name

MG

Nabp

NDC

Patient

Patient DOB

Patient Eff. Date

Patient Id

Patient SSN

Patient Term. Date

Payment

Pharmacy

Pharmacy Address

Pharmacy Phone

Provider

Provider Address 1

Provider Address 2

Provider DEA

Provider Degree

Provider Id

Provider NPI

Provider Office

Provider Specialty

Provider State

Provider Tax Id

Provider UPIN

Provider Zip

Quantity

Rx No

Status

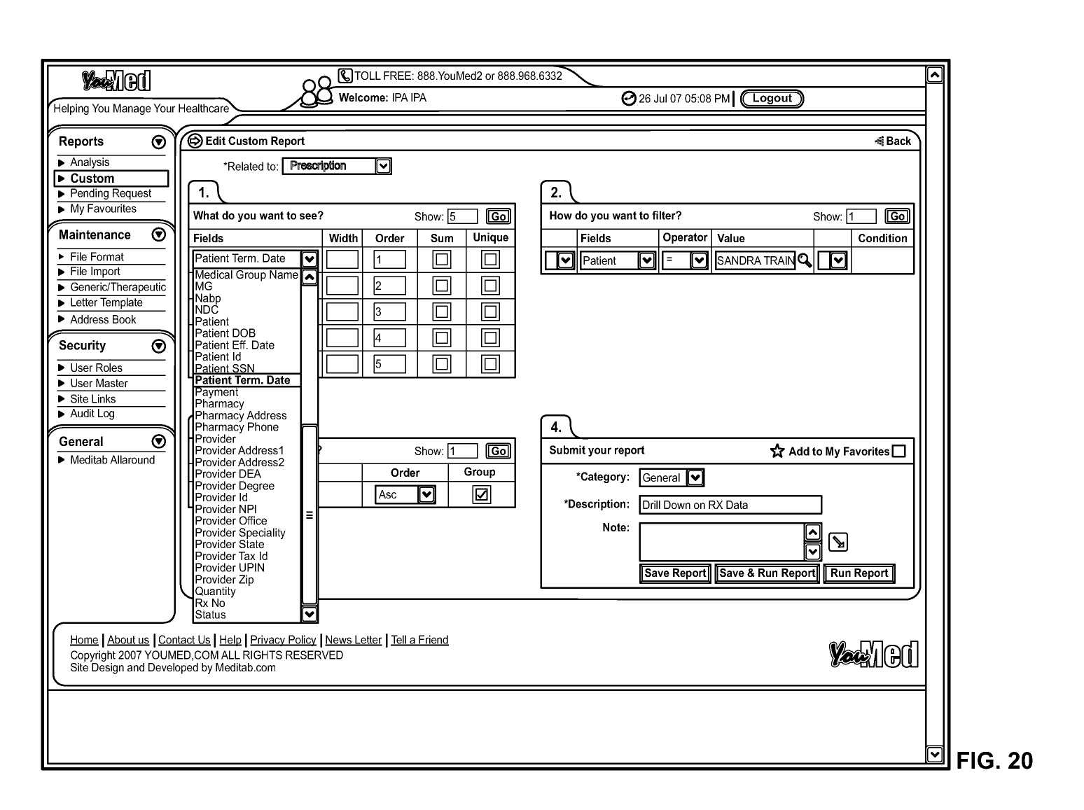

FIG. 19A is a diagram depicting a system that enables the particular information of FIGS. 19 and 20 to be accessed and reported on those screenshots. An authorized user 1901 is identified as an insurance provider, while other authorized users may be hospitals, physicians and/or patients. Each authorized user is able to send and receive communications through a network such as the Internet or an intranet. A database 1908 of prenatal records and a database 1907a of hospital records are maintained and can be accessed by certain authorized users through a network site homepage 1904, which in turn can be coupled to other potential authorized users through the Internet 1903 and a server 1905. A database 1906 of known patients and their conditions, including past said actions and clinical activity, as well as electronic medical records (EMRs), are also maintained for patients. Each authorized user is charged for accessing the databases. At least one server 1905 can also access and present information via a content aggregator 1910, a content integrator 1911, and an intelligent agent 1912, from each of the databases, which include drug records in database 1907a, hospital records in database 1908a, laboratory records in database 1908a, prenatal care records in database 1908, quality of care and pay for performance indicators in database 1909, and insurance claims and incentive indicators in database 1909a. For example, the system of FIG. 19A may be used to connect an insurance provider and a hospital or physician to databases 1906-1909 and 1907a-1909a, so that both the insurance provider and the hospital or physician clearly understand and receive information from those databases, including summary reports 1913, recommendations 1914. Incentive indicators from the database 1909a, as well as patient input and agreement regarding the recommendation, may be included.

FIG. 20 displays the remainder of the 50 fields from the menu in FIG. 19.

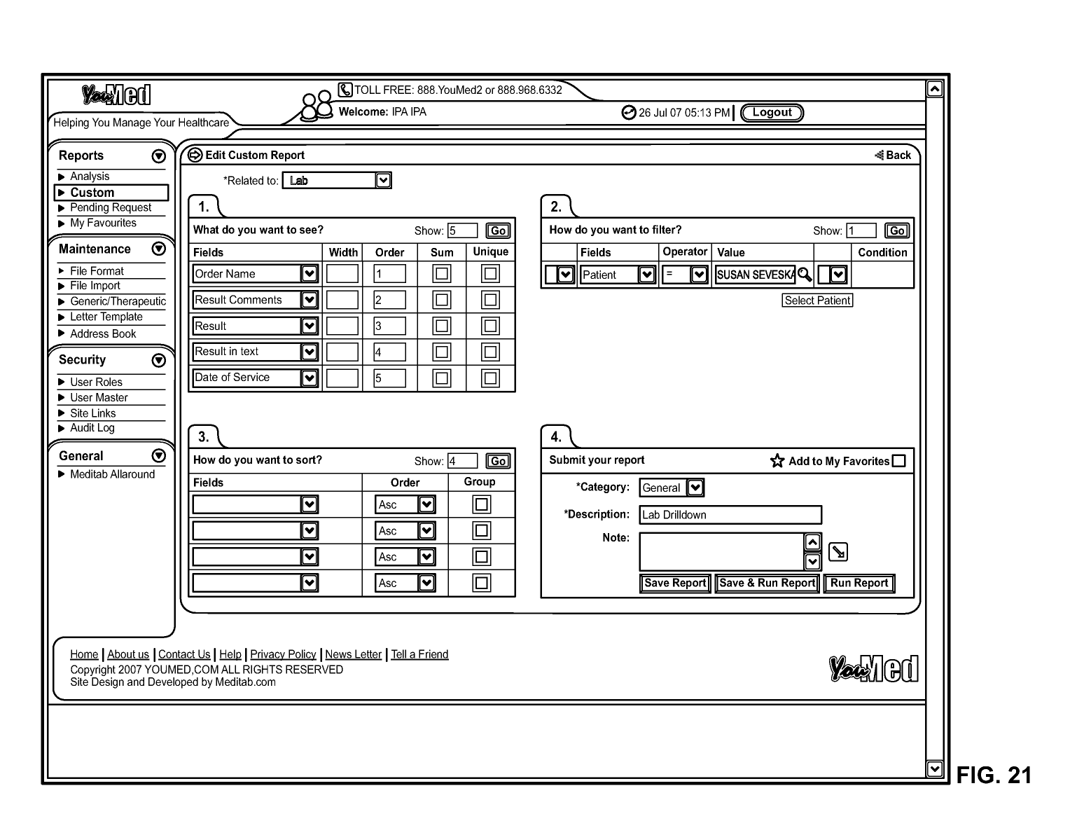

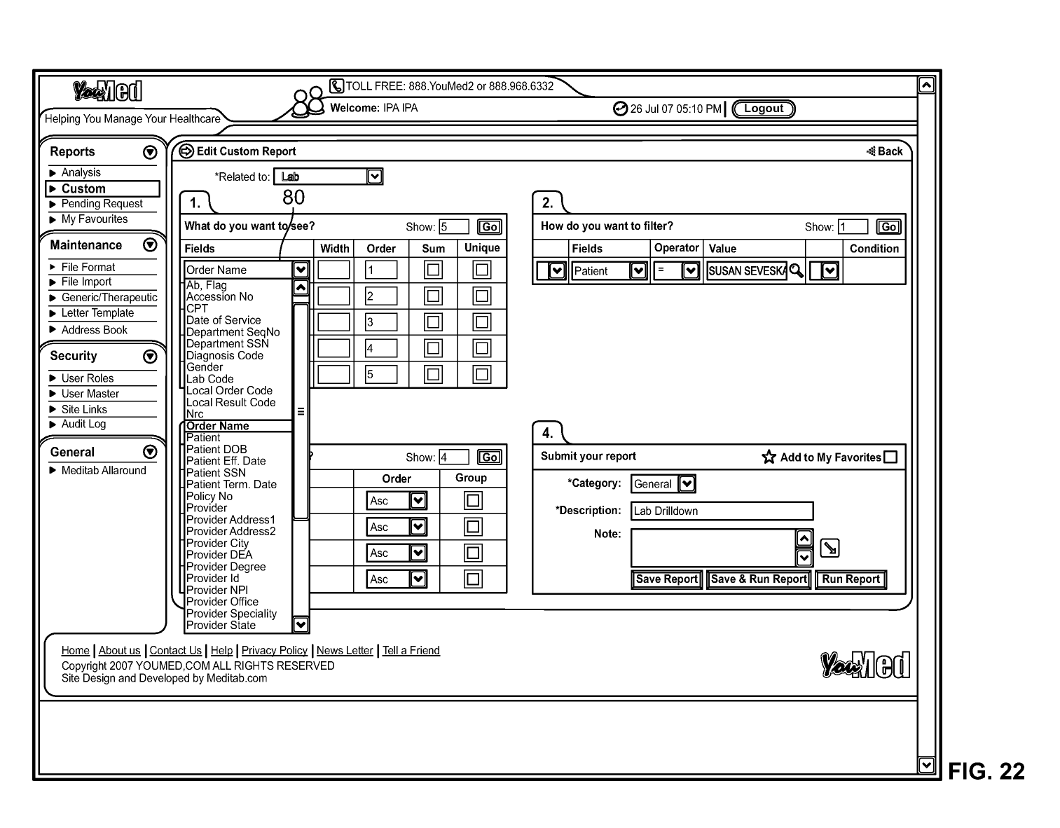

FIG. 22 is a screen shot of the page displayed in FIG. 21 with the pull-down menu of field names displayed for the first box 80 under the heading “Fields.” In this example, the report for “Lab Drilldown” has been selected from the list displayed in FIG. 12. This report queries the “Lab” database and 41 fields are displayed, namely:

Ab. Flag

Accession No

CPT

Date of Service

Department SeqNo

Diagnosis Code

Gender

Lab Code

Local Order Code

Local Result Code

Nrc

Order Name

Patient

Patient DOB

Patient Eff. Date

Patient SSN

Patient Term. Date

Policy No

Provider

Provider Address 1

Provider Address 2

Provider City

Provider DEA

Provider Degree

Provider Id

Provider NPI

Provider Office

Provider Specialty

Provider State

Provider Tax Id

Provider UPIN

Provider Zip

Quest Billing Identifier

Ref Range Alpha

Ref Range Low

Result

Result Comments

Result in Text

Result Name

Result Unit

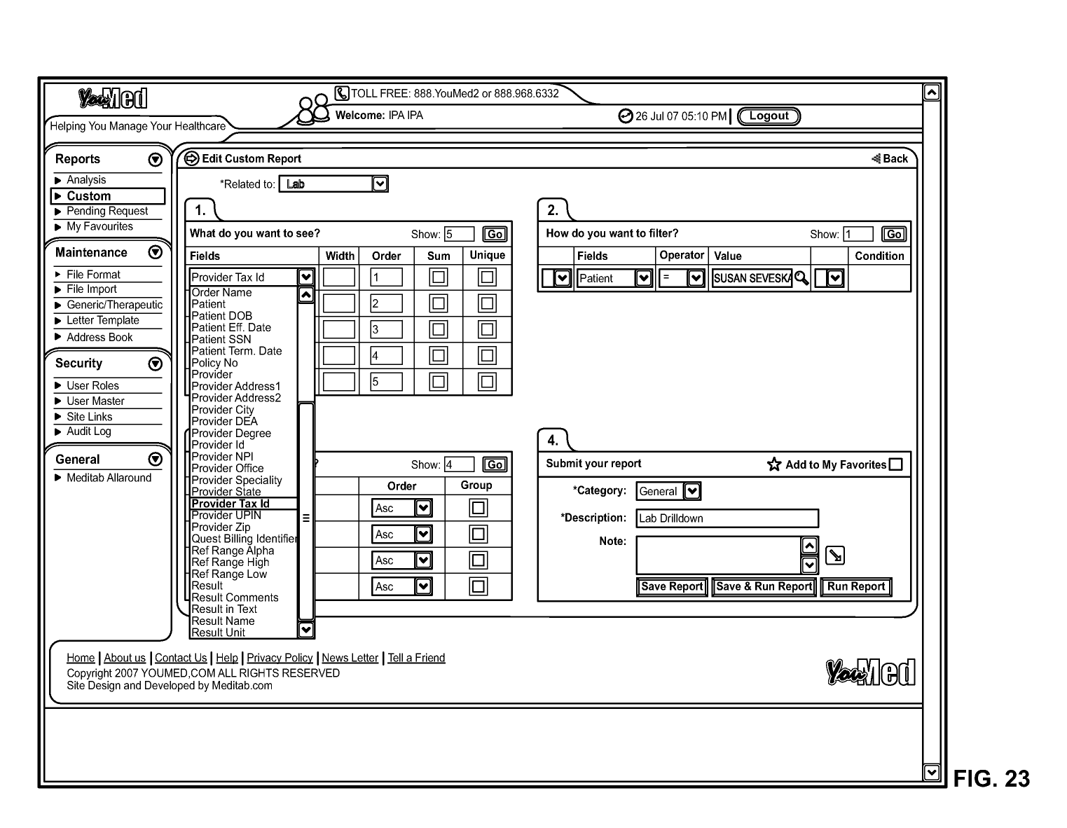

FIG. 23 displays the remainder of the 41 field names from FIG. 22.

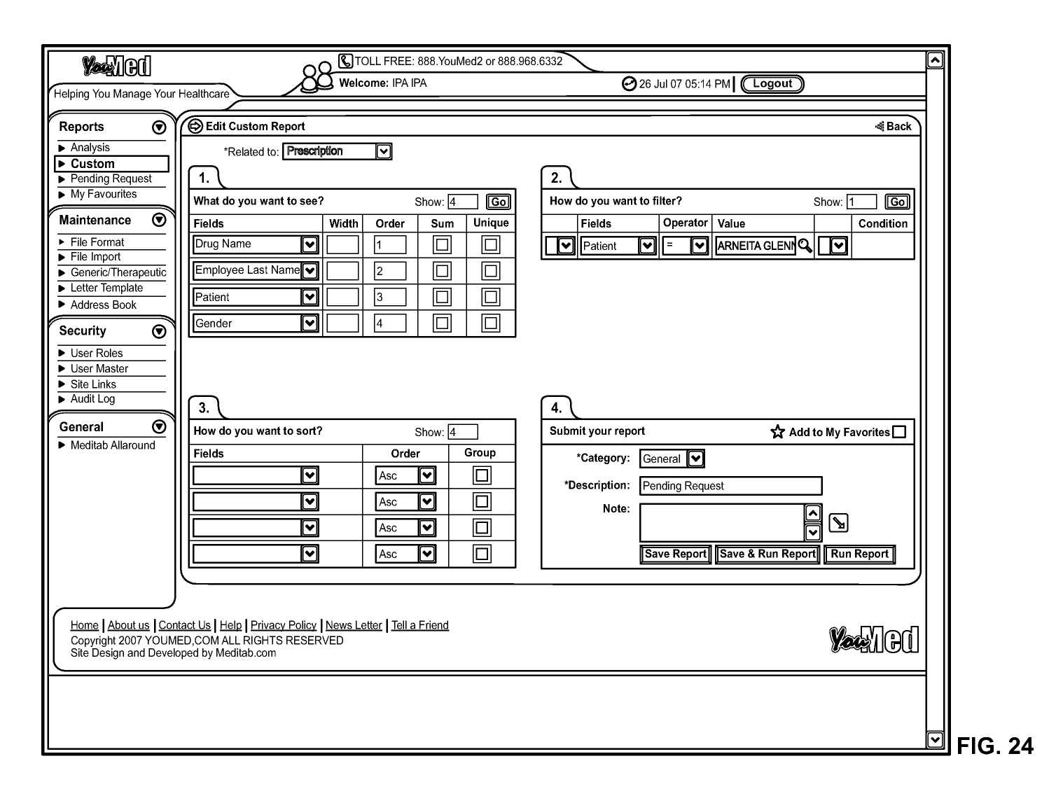

FIG. 24 is a screen shot of the page displayed when “General” is selected in the “Category” box and “Pending Request” is selected in the “Description” box, i.e., when “Pending Request” has been selected from the list displayed in FIG. 12.

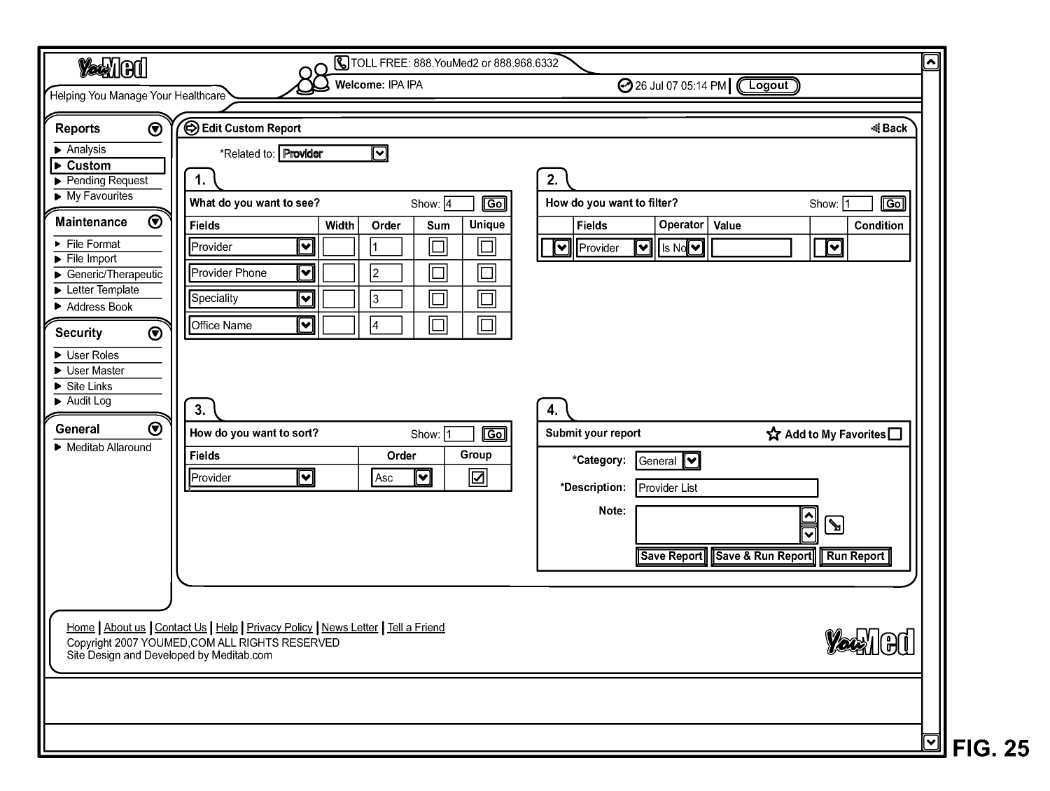

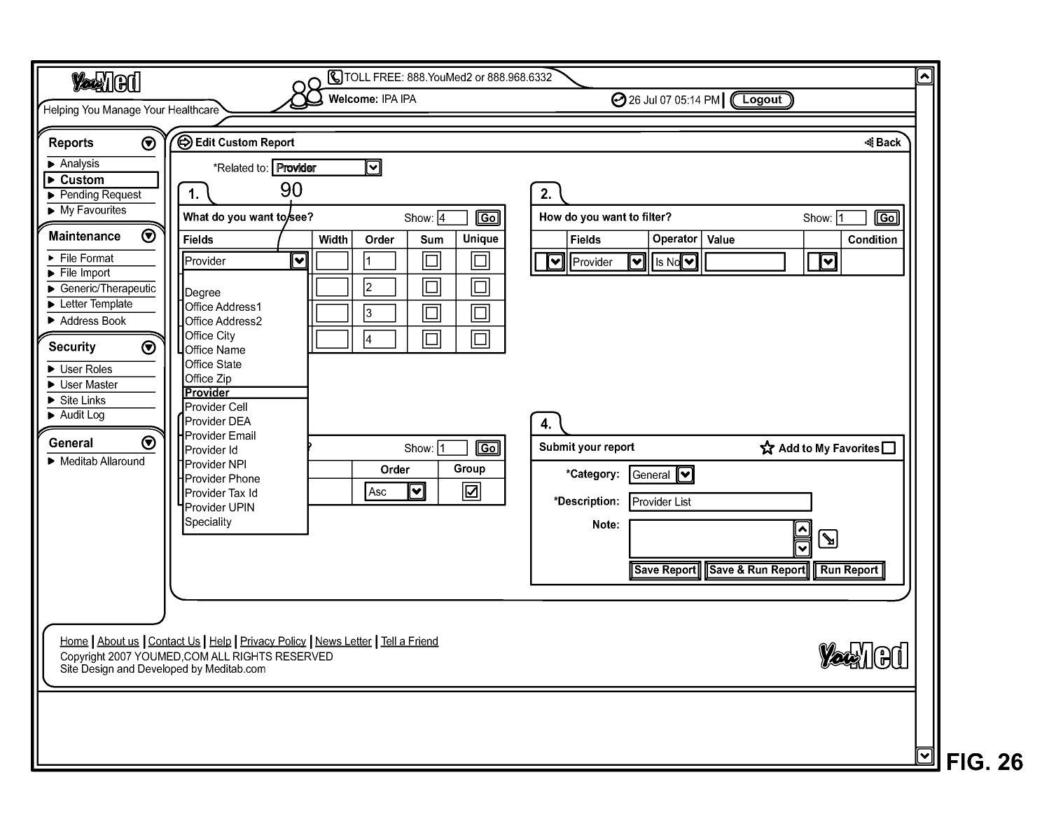

FIG. 25 is a screen shot of the page displayed when “General” is selected in the “Category” box and “Provider List” is selected in the “Description” box, i.e., when “Provider List” has been selected from the list displayed in FIG. 12. FIG. 26 is a screen shot of the page displayed in FIG. 25 with the pull-down menu of field names displayed in the box 90 under heading “Fields.” This report queries the “Provider” database and 17 fields are displayed, namely:

Degree

Office Address 1

Office Address 2

Office City

Office Name

Office State

Office Zip

Provider

Provider Cell

Provider DEA

Provider Email

Provider Id

Provider NPI

Provider Phone

Provider Tax Id

Provider UPIN

Specialty

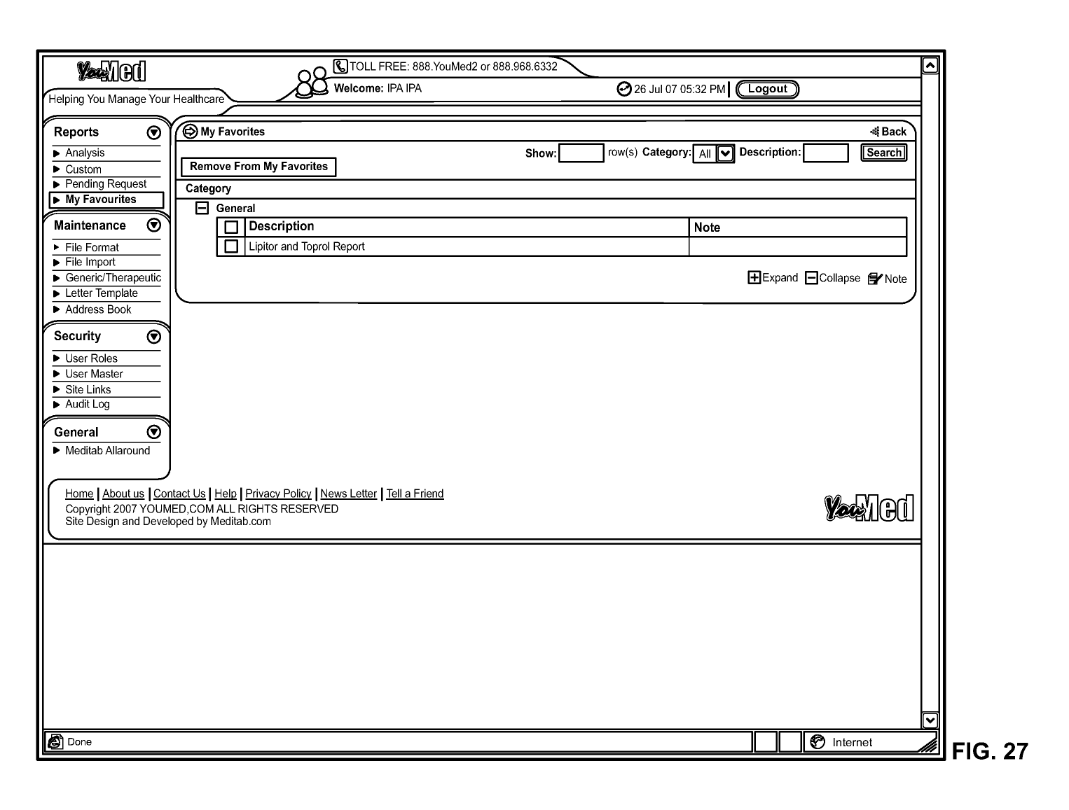

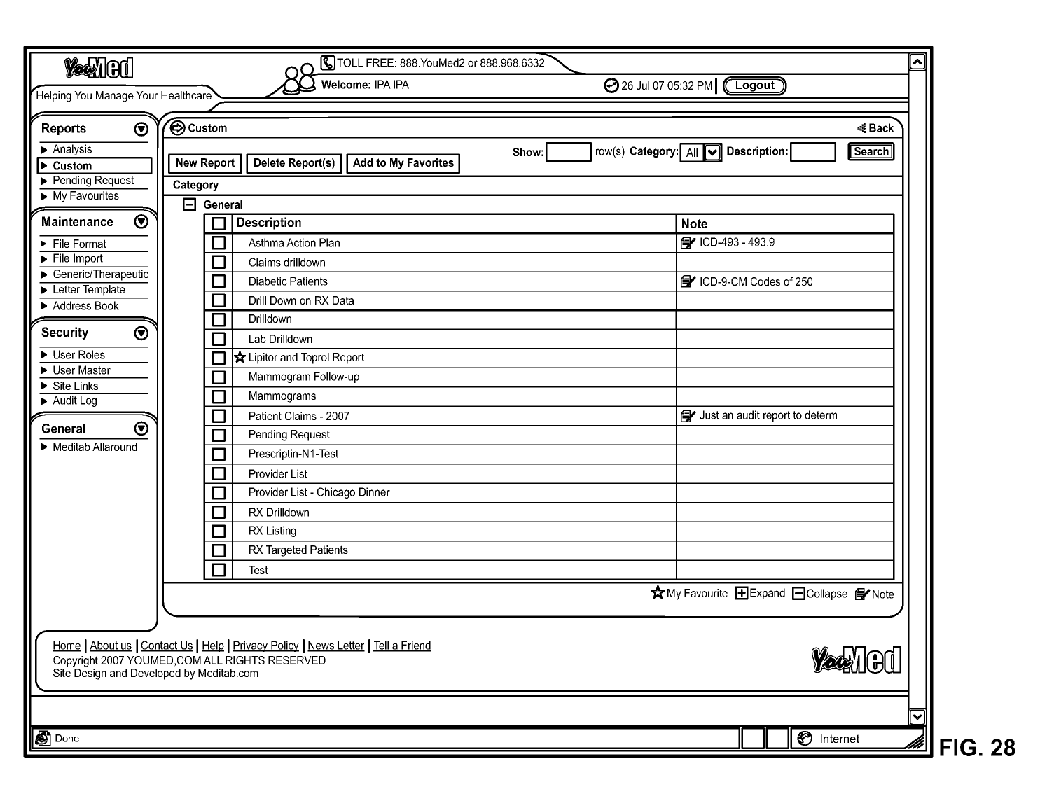

Looking again at the frame on the left-hand side, when the “My Favorites” option under the heading “Reports” is selected, users can view all the reports they have checked as “Add to my Favorites,” as shown in FIG. 27. In the original list of the different types of reports that is generated when the user selects the “Custom” option under “reports,” a star icon appears next to the reports marked as Favorite, as illustrated in the screen shot in FIG. 28.

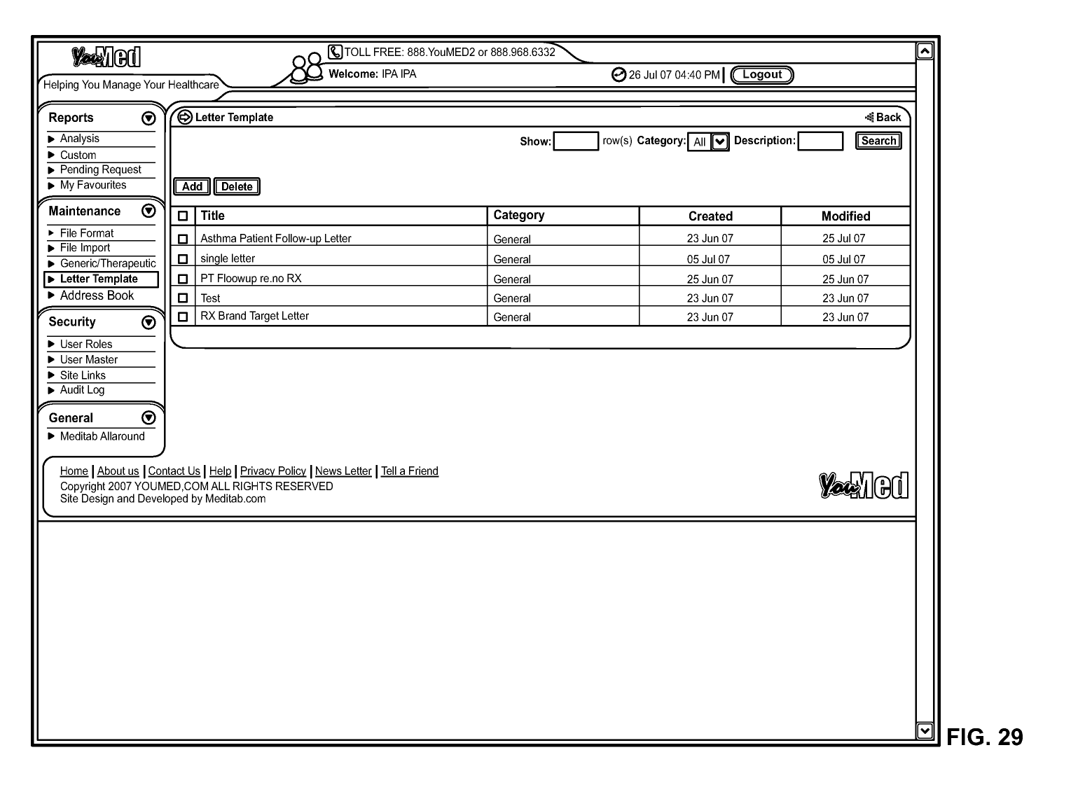

FIG. 29 is a screen shot of the page displayed when the user selects the “Letter Template” option under the heading “Maintenance” from the frame on the left-hand side. Displayed is a list of letter templates to facilitate communication with patients about a recommended “action plan,” such as the “Asthma Patient Follow-up Letter” in the list displayed in FIG. 29, or a specific recommended action to improve a patient's health care, such as the “PT Follow-up re: no RX” in the list displayed in FIG. 29, to remind a patient to take a prescribed drug which the database shows the patient has not filled. The five letter templates listed in the example in FIG. 29 are simply examples of a multitude of different templates that can be created by the users, and each template can be given any title desired by the users.

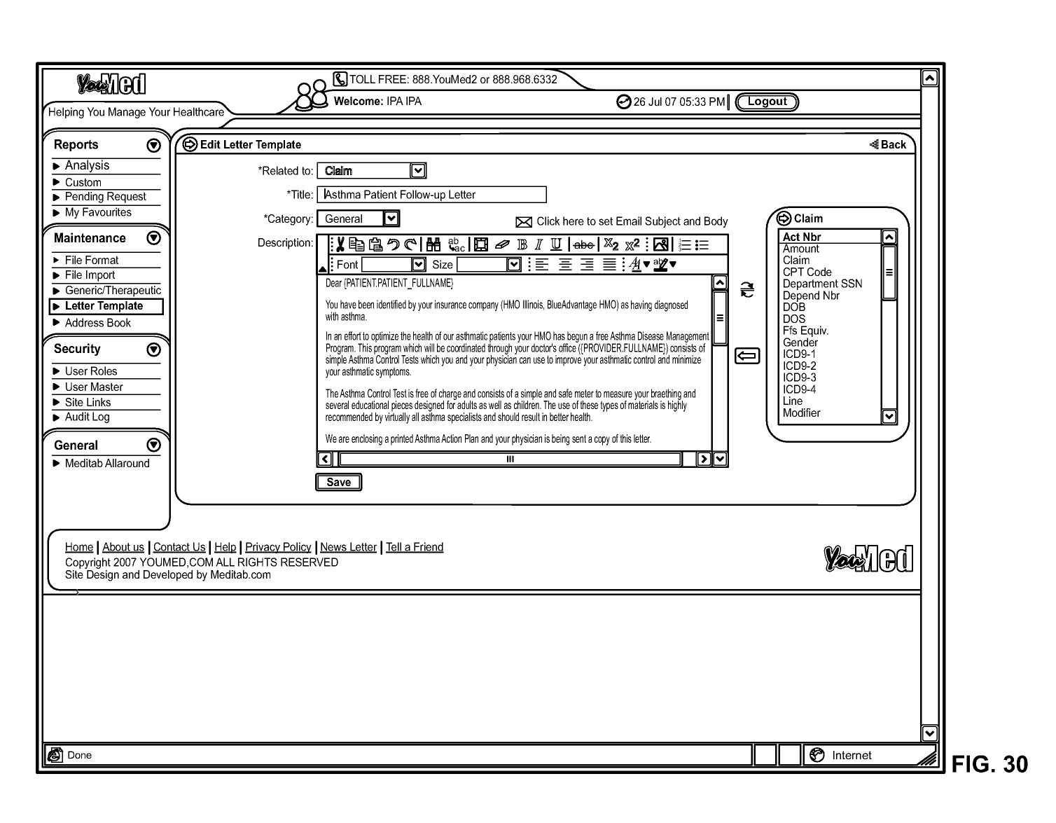

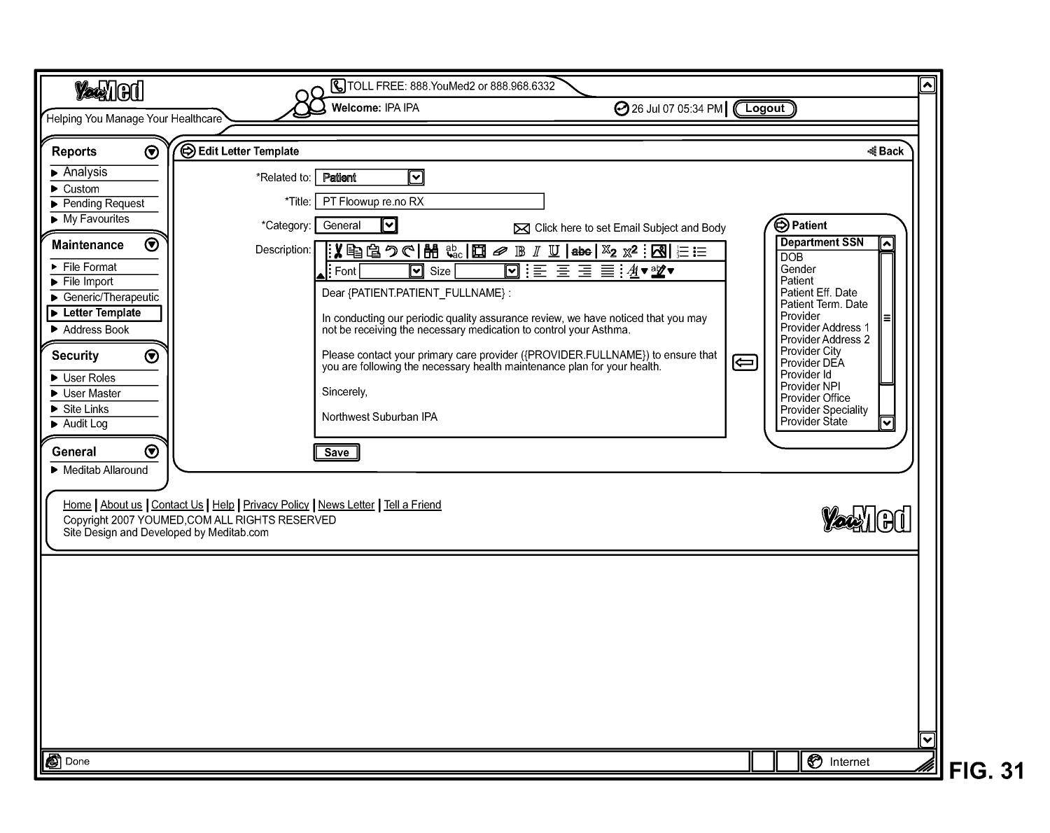

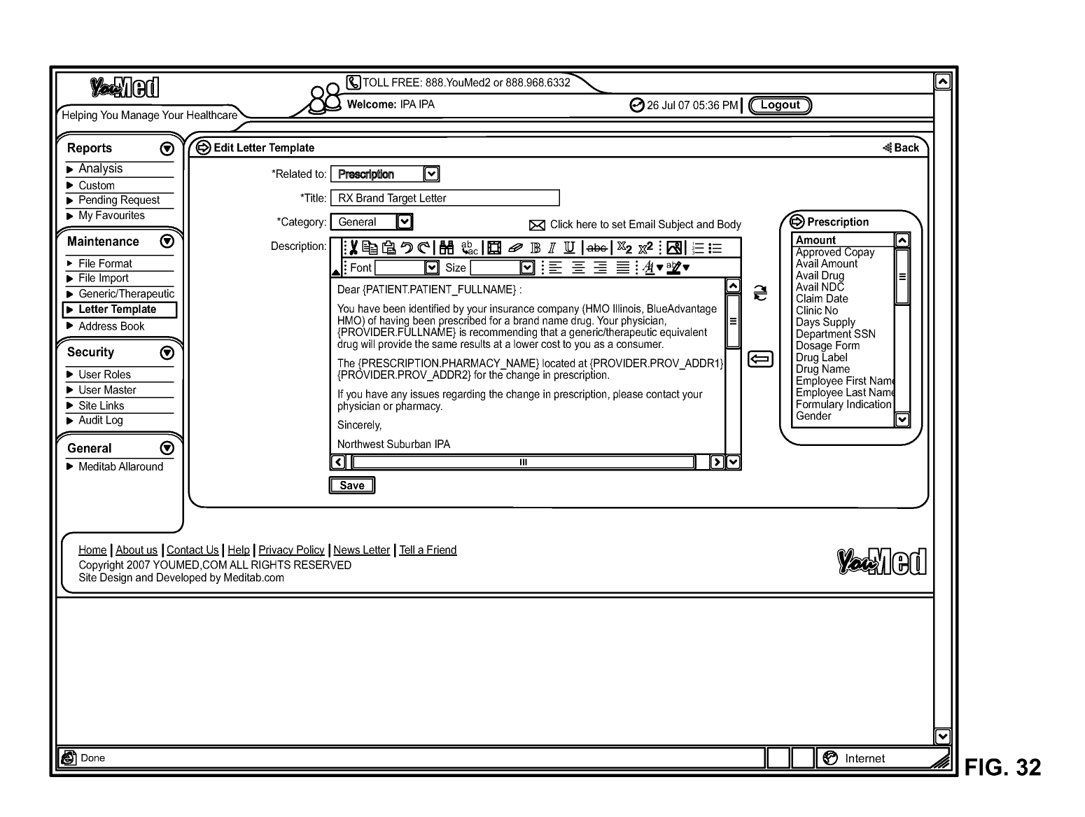

FIG. 30 is a screen shot of the page displayed when the template “Asthma Patient Follow-up Letter” is selected. In this particular example, the patient is being notified of being diagnosed with asthma. FIG. 31 is a screen shot of the page displayed when the template “PT Follow-up re: no RX” is selected. In this illustration, a patient diagnosed with asthma is being notified of not receiving the necessary medication to control the patient's asthma. FIG. 32 is a screen shot of the page displayed when the template “RX Brand Target Letter” is selected. This letter notifies the patient of the availability of a physician-recommended generic drug to substitute for a prescribed brand name drug.

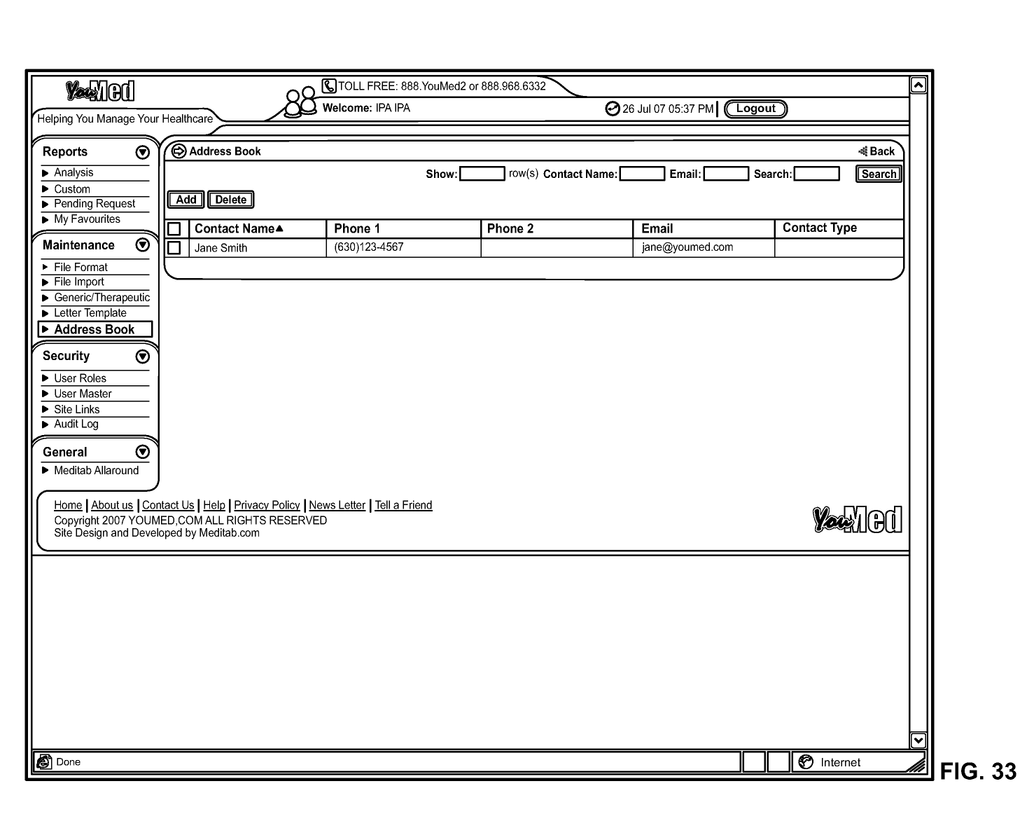

FIG. 33 is a screen shot of the page displayed when the option “Address Book” under the heading “Maintenance” is selected in the frame on the left-hand side. This page permits searches for contacts by name and/or email address, as well as the addition and deletion of contact information. Any contacts that have been added and saved are displayed on this page. The “Add” and “Delete” buttons above the field “Contact Name” are used to add and delete contact information.

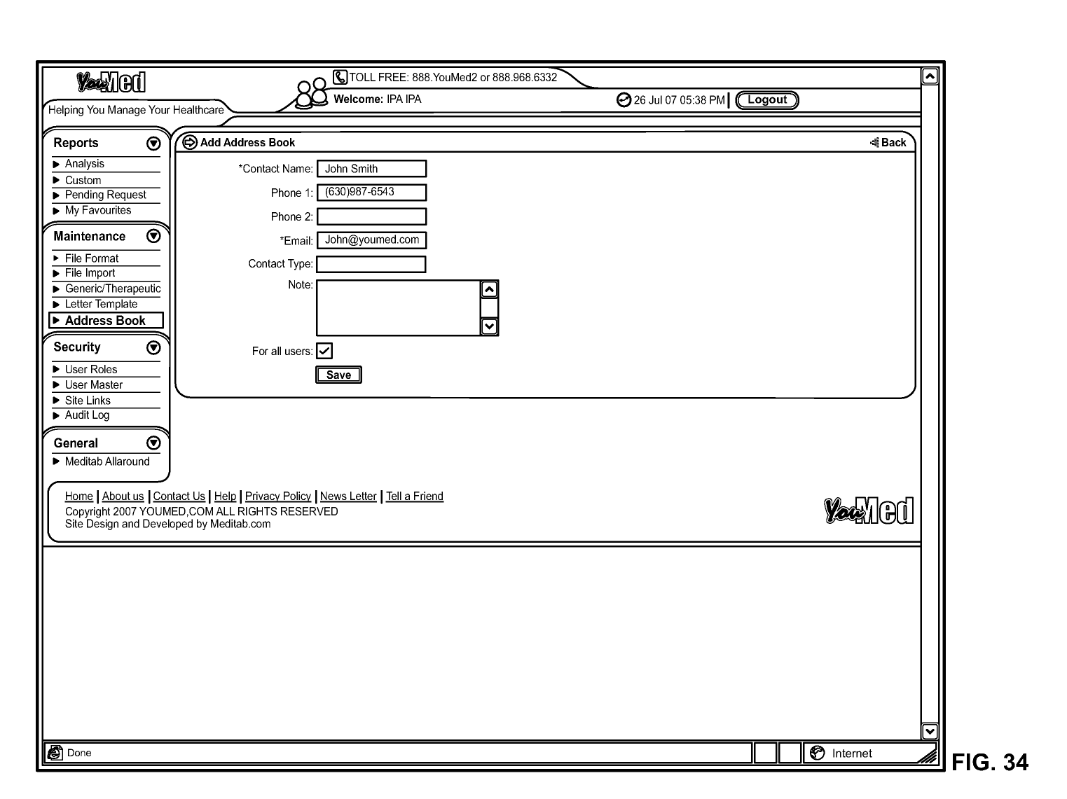

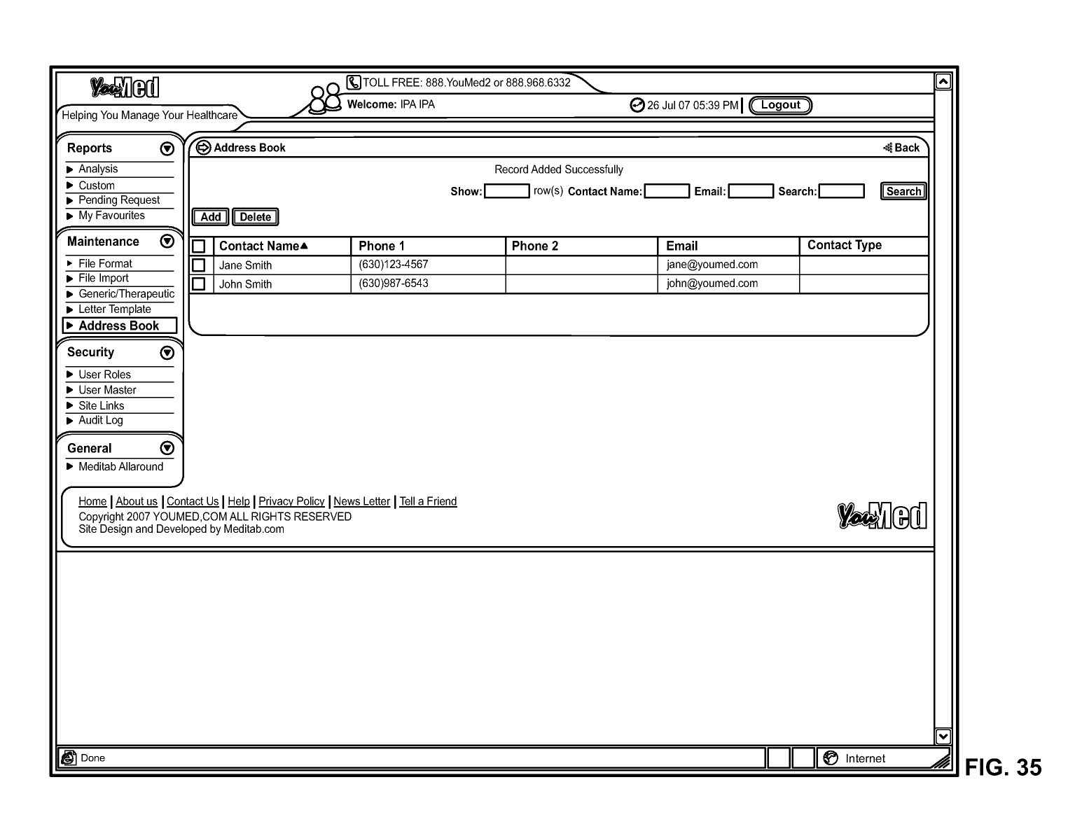

FIG. 34 is a screen shot of the page displayed when the “Add” button in FIG. 33 is clicked and contact information is entered into certain of the fields. The box 110 adjacent “For all users” can be checked to make the contact visible to all users. Leaving the box unchecked results in the contact being visible to only the current user. Clicking the “Save” button in FIG. 34 displays the page depicted in FIG. 35, showing the user the updated contact list.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of encouraging the use of generic drugs, comprising:
maintaining a database of (1) prescribed branded drugs by patient and health care provider,
maintaining a data base of (2) generic drugs that can be substituted for identified branded drugs,
maintaining a data base of (3) actual substitutions of said generic drug for said prescribed branded drug by a health care provider,
maintaining (4) incentives available to substitute said generic drug for said prescribed branded drug, and
delivering to at least certain of said health care providers an incentive to substitute said generic drug for said prescribed branded drug.

2. The method of claim 1 which includes:
requesting agreement by said health care provider to substitute an identified generic drug for a prescribed branded drug, for use by said patient, and
communicating to said patient (1) the availability of said generic drug as a substitute for said prescribed branded drug and (2) the agreement by said health care provider to such substitution.

3. A method of encouraging the use of a health care program recommended to a patient by a health care provider, comprising:
maintaining a database of recommended health care actions by patient and health care provider,
maintaining a database of recommended changes in recommended health care actions by patient and health care provider,
requesting agreement by a health care provider to said recommended changes for at least one patient of that provider,
communicating to said patient (1) said recommended changes and (2) the agreement by said health care provider to such recommended changes,
maintaining a database of actual changes in recommended health care actions by health care provider, and
delivering to at least certain of said health care providers an incentive to recommend health care actions that include said recommended changes.

4. The method of claim 2 in which said recommended health care actions include a plurality of plans selected from the group consisting of asthma treatment plans, cigarette cessation plans, and plans for compliance with screening for cervical cancer, breast cancer, colon cancer, diabetes, cholesterol, childhood immunization programs, mammogram programs and prescribed medications.

5. A method of supplying electronic prenatal records to hospitals, comprising:
collecting prenatal records for patients, each prenatal record including at least laboratory test results, ultrasound results, recommended medications, doctor visit dates and a medical history of the patient,
requesting agreement by health care providers of said patients to the collection and maintenance of said prenatal records,
maintaining said prenatal records at a network site accessible by authorized health care providers,
maintaining a record of the instances of accessing of said prenatal records on said network site by each of said authorized health care providers, and
charging said authorized health care providers for accessing said prenatal records on said network site, based on the number of instances of accessing said records by each accessing health care provider.

6. The method of claim 5 which includes maintaining a database of compilations of the types of information accessed in said prenatal records on said network site, without identifications of patients or health care providers, and selling said compilations.

7. A method of encouraging the use of a health care program recommended to a patient by a health care provider, comprising:
maintaining a database that includes recommended health care actions by patient and health care provider, and electronic medical records of said patient and health care provider,
querying said database to identify patients that have not complied with said recommended health care actions, and
delivering to said identified patients messages recommending actions to be taken to comply with said recommended health care actions.

8. The method of claim 1 in which said messages include at least one type of message selected from the group consisting of a letter or email based on a template provided by said system, a pre-recorded or synthesized telephone message provided by said system, and a text message based on a template provided by said system.

9. A method of providing access electronic health management records, comprising:
maintaining a database that is a composite of an electronic medical records (“EMR”) database for a known population of patients,
a prescription drug records database,
a prenatal care database,
a hospital records database for at least the patients in the EMR database,
claims databases from health insurance providers for at least the patients in the EMR database,
a laboratory records database for at least the patients in the EMR database,
maintaining a network site through which said database can be accessed by authorized users, and
charging said authorized users for accessing said database via said network site, based on the number of instances of accessing said database by each authorized user.

10. A method of providing access electronic health management records, comprising:
maintaining a database that is a composite of an electronic medical records (“EMR”) database for a known population of patients,
maintaining a prescription drug records database,
maintaining a prenatal care database,
maintaining a hospital records database for at least the patients in the EMR database,
maintaining claims databases from health insurance providers for at least the patients in the EMR database,
a laboratory records database for at least the patients in the EMR database,
maintaining a network site through which said database can be accessed by authorized users, and
determining whether information in said database was accessed for a patient identified in a claim for payment for medical treatment of that patient, and if the answer is affirmative, making an extra payment of said claim.

11. The method of claim 10, whereby the said authorized user is a health care provider and accesses the said database over the Internet or an intranet, and receives a report or a recommendation on said authorized user's computer or other device in the following steps:
the said authorized user queries said database regarding treatment options and other data in said database regarding said patient,
said database is connected to at least one server and to other said databases;
said at least one server comprises means to aggregate said data;
said at least one server comprises means to integrate said data from said database and said other databases;
said at least one server comprises means to summarize said aggregated and said integrated data into a format selected from the group of video, audio or text presented to said authorized user on said computer or said other device;
said summarized data is reported to the said authorized user as a recommendation or said patient; and
said summarized data is reported to the said authorized user in the form of an incentive selected from the group of an extra payment, an intangible reward, a tangible reward, cost savings, and time saved, to said authorized user.

12. The method of claim 10, whereby the said authorized user is an insurance provider and accesses the said database over the Internet or an intranet, and receives a report or a recommendation on said authorized user's computer or other device in the following steps:
the said authorized user queries said at least one database regarding said treatment options and other said data in said at least one database regarding said patient, and said actions taken by said physician or said health care provider,
said database is connected to at least one server and to other said databases;
said at least one server comprises means to aggregate said data;
said at least one server comprises means to integrate said data from said database and said other databases;
said at least one server comprises means to summarize said aggregated and said integrated data into a format selected from the group of video, audio or text presented to said authorized user on said computer or said other device;
said summarized data is reported to the said authorized user as a recommendation for said patient; and
said summarized data is reported to the said authorized user in the form of an incentive to said physician or said health care provider selected from the group of an extra payment, an intangible reward, a tangible reward, cost savings, and time saved, to said physician or said care provider.

13. The method of claim 10, whereby the said authorized user is a patient and said patient accesses the said database over the Internet, and receives a report or a recommendation on said authorized user's computer or other device in the following steps:
the said authorized user queries said at least one database regarding said treatment options and other said data in said at least one database regarding said patient who is the said authorized user, and said actions taken by said physician or said health care provider,
said database is connected to at least one server and to other said databases,
said at least one server comprises means to aggregate said data,
said at least one server comprises means to integrate said data from said database and said other databases,
said at least one server comprises means to summarize said aggregated and said integrated data into a format selected from the group of video, audio or text presented to said authorized user on said computer or said other device,
said summarized data is reported to the said authorized user as a recommendation for said patient who is the said authorized user, and
said summarized data is reported to the said authorized user in the form of an incentive to said patient selected from the group of an intangible reward, a tangible reward, reduced cost, and wellness plan options.
